(19) United States
(12) Patent Application Publication
(10) Pub. No.: US 2026/0296570 A1
(43) Pub. Date: Oct. 1, 2026

(54) PICKUP TRUCK TAILGATE LATCH

(71) Applicant: BAE Industries, Inc., Auburn Hills, MI (US)

(72) Inventors: David Grable, Rochester Hills, MI (US); Joel Hudson, South Lyon, MI (US); Tristan Putnam, Holly, MI (US); Jesse Leonard, White Lake, MI (US)

(73) Assignee: BAE Industries, Inc., Auburn Hills, MI (US)

(21) Appl. No.: 19/700,962

(22) Filed: Jun. 8, 2026

Related U.S. Application Data
(63) Continuation-in-part of application No. 18/769,842, filed on Jul. 11, 2024, now Pat. No. 12,649,527.
(60) Provisional application No. 63/526,222, filed on Jul. 12, 2023.

(51) Int. Cl. B62D 33/037

(52) U.S. Cl. CPC B62D 33/037

(57) ABSTRACT

A latch assembly for pivotally securing a tailgate to a truck bed including a body adapted to being secured to a side of the tailgate and enclosing each of a pawl and sector. A pivot support is adapted to being secured to each of first and second opposing side locations of the tailgate in alignment with a main pivot extending through said sector. The pawl exhibits projecting portions which oppose circumferentially offset and radial projection portions of the sector. A torque is exerted by the pawl against the sector at selected downward and return upward pivoting directions, permitting rotation of the tailgate between each of upright, intermediate and down positions.

### CROSS REFERENCE TO RELATED APPLICATIONS

The present application is a continuation in part of and claims priority from U.S. Ser. No. 18/769,842 filed Jul. 11, 2024. The '842 application claims priority from U.S. Ser. No. 63/526,222 filed Jul. 12, 2023.

### FIELD OF THE INVENTION

The present invention relates generally to truck tailgate latches. More specifically, the present invention teaches an improved truck tailgate lower latch which replaces a traditional lower cable and which provides for adjustability of the tailgate between each of a vertical position, one or more intermediate angled positions (typically multiple intermediate positions), and a fully downwardly rotated horizontal position relative to the supporting sidewalls of the truck pickup bed. For purposes of the present invention, the vertical and horizontal positions are defined as establishing a ninety degree angle, with the one or more intermediate positions being at any angular position between zero and ninety degrees.

### BACKGROUND OF THE INVENTION

The prior art is documented with examples of truck tailgate latches. A first example of this is shown in U.S. Pat. No. 10,882,570 to Sharp which teaches a tailgate latch system having an actuatable button located on a pickup truck tailgate. At least one rotatable rod is located in the tailgate interior that is configured to rotate clockwise or counterclockwise upon actuating the button and a rotary latch that is configured to disengage a bedside striker pin upon rotation of the at least one rotatable rod.

Also referenced is the retrofit tailgate latching mechanism and method of Blank, US 2023/0008925 which includes a retrofit housing with actuating handle configured to be connected to the tailgate. A linkage assembly is joined with the actuating handle at a proximal end thereof and extends through and within the tailgate toward a stop catch of the truck bed sidewall. A cable is connected between proximal and distal ends of the linkage assembly wherein actuation of the actuating handle to an open position pulls the distal end of the linkage assembly toward the actuating handle and disengages the linkage assembly from the stop catch to permit the tailgate to be pivoted to a lowered position.

### SUMMARY OF THE INVENTION

The present invention discloses a latch assembly for pivotally securing a tailgate to a truck bed, including a package interior defining body adapted to being secured to a side of the tailgate and enclosing each of a sector, pawl and cam. A main pivot support is adapted to being secured to an opposing side location of the tailgate, the pivot support including a rotatable portion slaved to the sector. Rotation of the cam in turn actuates the pawl to disengage from the sector, permitting in turn rotation of the tailgate between each of vertical, intermediate angled and fully downwardly rotated horizontal positions relative to the supporting sidewalls of the truck pickup bed.

In any embodiment, the tailgate can be incorporated into either of the exterior or interior sides of the tailgate and includes a reconfigured version of the sector which is rotated via a main pivot. The cam component of the first embodiment is removed, with a redesigned spring loaded pawl engaging the sector at various locations associated with each of upright, intermediate and down positions. Without limitation, the latch assembly can be integrated into a powered version in which a motor actuates the tailgate between the various rotational positions relative to the truck bed.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the latch assembly according to the present invention;

FIG. 2 presents an environmental perspective view of a tailgate incorporating the latch assembly of the present invention as a lower tailgate latch in combination with an upper latch, these being arranged on each of opposite sides of the tailgate for securing the same to opposing locations of the surrounding truck bed;

FIG. 3 is an enlargement of the latch assembly of FIG. 2 depicting selected package defining plates in partially transparent fashion to better illustrate the cam, pawl and sector components;

FIG. 4 presents a plan side view of the tailgate in an upright vertical position with the lower latch assembly unlocked and the upper latch locked;

FIG. 5 is an enlargement of the lower latch assembly in FIG. 4 and again showing the cam, pawl and sector components in the unlocked position;

FIG. 6 presents a succeeding view to FIG. 4 and depicting the truck tailgate rotated to an intermediate forty five degree position, at which the lower latch is re-engaged to secure the tailgate in position;

FIG. 7 is an enlargement of the lower latch assembly of FIG. 6 and depicting the lower latch re-engaged at the intermediate tailgate position;

FIG. 8 presents a further succeeding view to FIG. 6 and depicting the truck tailgate in a fully downwardly rotated horizontal position at which the lower latch assembly is re-engaged;

FIG. 9 is an enlargement of the lower latch assembly in FIG. 8 depicting the lower latch in the re-engaged position;

FIG. 10 is a perspective view of the tailgate and further illustrating the latch-to-tailgate mounting bushings as well as the rubber or elastomer seal extending around the perimeter of the assembly in order to protect the internal components of the latch from external contaminants and objects, the presence of which could inhibit operation of the locking mechanism;

FIG. 11 is a one-hundred and eighty degree rotated view of FIG. 10 and depicting the release cable or link rod system which can be routed inside the tailgate for simultaneously releasing the upper and lower latches when the handle on the back of the tailgate is pulled, as well as depicting a “D” shaped tenon which attaches to a torsional spring located inside of the liftgate for inducing a torque to assist lifting of the tailgate;

FIG. 12 is an exploded view depicting the pivotally supported attachment of the lower latch assembly to the opposing side edge of the truck bed and which includes brackets mounted to the truck body on both sides of the tailgate, these further including square shaped cavities which receive mating hubs of the main pivot body of the lower latch, with screws installed for engaging the hubs within the cavities;

FIG. 13 is a succeeding assembled view of FIG. 12;

FIG. 14 is a lower sectional view of the latch assembly, after being mounted to the vehicle bed, and depicting the sector and main pivot pin being fixed;

FIG. 15 succeeding FIG. 14 and depicting the latch and tailgate rotating round the fixed sector and fixed portion of the main pivot;

FIG. 16 presents an environmental perspective view of a tailgate incorporating the latch assembly according to a further embodiment of the present invention and which again includes a lower tailgate latch in combination with an upper latch, these being arranged on each of opposite sides of the tailgate for securing the same to opposing locations of the surrounding truck bed;

FIG. 17 is a first perspective of tailgate hinge latch assembly of FIG. 16 and depicting each of the upper holes or bushings for mounting the hinge to the tailgate, in combination with a double “D” or spline end configurations of the main pivot, such operable in a variety of variants for interfacing with each of a motor associated with an optional powered variant, a damper component for slowing rotational descent/drop of the tailgate, or a lift assist spring component;

FIGS. 17A-17D respectively depict an end of the main pivot opposite the larger spline exhibiting any of a D shape (see FIG. 17A), a double D or “DD” profile (FIG. 17B), a first configuration of a smaller diameter spline (FIG. 17C), and a second configuration of a smaller spline (FIG. 17D) which interfaces with any of a torsional spring, damper, or electric motor (via its output shaft);

FIG. 18 presents a one hundred and eighty degree rotated view of the latch assembly of FIG. 17 and depicting spline configuration of the main pivot;

FIG. 19 presents a partially transparent view of latch assembly of FIG. 16 and depicting a variation of the ratchet mechanism in which the redesigned pawl incorporating an over center spring, with the external spline pattern again shown which operates as a generic connector that allows for accommodating a variety of truck body mounting scenarios;

FIG. 20 presents an exploded view of the latch assembly being inserted into a bottom corner facing aperture of the tailgate for providing an internal mounting option;

FIG. 21 illustrates an assembled view of a further mounting variant in which the latch assembly is mounted to an outside surface of the tailgate;

FIGS. 22-24 present a series of exploded, assembled and environmental installed view of the latch assembly and including a pivotally supporting mounting bracket which are mounted to side facing locations of the truck bed opposing the tailgate;

FIGS. 25-26 depict a pair of exploded and assembled environmental view of the tailgate latch assembly according to the present invention which is installed in rotationally supporting fashion to each of opposing side locations of the truck bed according to an existing support bracket and square shaped mounting configuration of a main pivot;

FIG. 27 is an exploded view of the latch assembly according to the embodiment of FIG. 16 et. seq. of the present invention;

FIGS. 28-30 present a series of sectional views of the pawl component rotationally mounted between the inner and outer support plates, respectively via each of an omega spring and rivet, an aperture formed in the inner plate, or a torsional/coil spring;

FIG. 31 presents a lower sectional view of the tailgate latch in the upright position in which the pawl is depicted in an open/disengaged position so that the tailgate is free to rotate downwardly;

FIG. 32 presents a similar view to FIG. 31 and depicting the tailgate latch in an intermediate pivoted threshold position in which there is no torque exerted on the pawl from the spring, beyond which continued downward rotation of the tailgate causes a reverse torque to be exerted on the pawl;

FIG. 33 presents a further succeeding view of the tailgate in a down position in which the pawl is in the lock position with a clockwise exerted torque, at which the tailgate is free to rotate upwardly;

FIG. 34 succeeds FIG. 33 and depicts an upwardly intermediate returning intermediate location of the tailgate latch which is assisted by the reverse torque exerted on the pawl;

FIG. 35 succeeds FIG. 34 and depicts the pawl in a further upwardly rotated threshold position with the torque from the spring exerted on the pawl is removed, and at which continued upright rotation of the tailgate results in the torque on the pawl to be reversed;

FIG. 36 further depicts the tailgate in the returned upright position in which the pawl is in the open/disengaged position and the tailgate is again free to rotate downwardly;

FIG. 37 is a frontal perspective of a combination of a lower latch assembly, shown in combination with a separate and upper split tailgate latch assembly according to a further embodiment of the present invention;

FIG. 38 is a rotated rear looking perspective of FIG. 37;

FIGS. 39A-39B collectively provide an exploded view of the lower and upper latch assemblies of FIG. 37;

FIG. 40 presents a first of a number of progression plan illustrations of the lower latch assembly of FIG. 37 with the housing cap removed and initially depicting the gear, pawl, cinching cam and sector in the locked upright position;

FIG. 41 is a sectional cutaway along line 41-41 of FIG. 40 and depicting the cinch rivet and bushing for rotatably supporting the pawl blocker against the inner surface of the sector so that rotation of the pawl block blocker is influenced by the protuberance located on the rear housing, along with showing the pawl and cinch cam;

FIGS. 42A and 42B present first and second rotated perspectives of the package defining components of the lower latch assembly shown in FIG. 40 with covers removed, with FIG. 42B better illustrating the cam follower pinned underneath the pawl for interacting with the pawl blocker as directed by the rotation of the inner protuberance;

FIG. 43 is a succeeding view to FIG. 40 depicting an initial unlock position in which the cable actuated lever in FIG. 39A is rotated in order to initiate counterclockwise rotation of the release gear, with opposing clockwise rotation of the pawl until contacting the downward flange portion of the cinch cam and prior to the cinch cam clearing a swing arc defined with the cinch bushing for permitting rotation of the latch assembly relative to the fixed sector;

FIGS. 44A and 44B present first and second rotated perspectives of the package defining components corresponding to FIG. 43;

FIG. 45 is succeeding progression to FIG. 43, again depicting the pawl and pawl blocker in partial phantom, and in which an initial contact is made by the inner protrusion of the main lower housing as it is rotated into contact with the rotatably supported pawl blocker;

FIGS. 46A and 46B present first and second rotated perspectives of the package defining components corresponding to FIG. 45;

FIG. 47 is a progression of FIG. 45 and showing the inner protuberance further rotating the pawl blocker into contact with the cam follower in order to pass over the intermediate lock position and permit downward rotation of the tailgate;

FIGS. 48A and 48B present first and second rotated perspectives of the package defining components corresponding to FIG. 47;

FIG. 49 is a progression of FIG. 47 and depicting a sliding interface established between the pawl supported cam follower and pawl blocker during ongoing downward rotation of the tailgate;

FIGS. 50A and 50B present first and second rotated perspectives of the package defining components corresponding to FIG. 49;

FIG. 51 is a further progression of FIG. 49 and depicting the rotatably supported pawl blocker at a maximum rotation angle relative to the pawl and cam follower, corresponding to downward rotation of the tailgate passing the intermediate angular support position (also termed middle or intermediate sector support or tooth) defined by the sector, and at which point contact is handed off from the pawl blocker to the pawl middle tooth support;

FIGS. 52A and 52B present first and second rotated perspectives of the package defining components corresponding to FIG. 51;

FIG. 53 is a further progression to FIG. 51 representing the tailgate latch in a fully downward rotated position and by which the inner housing protrusion has rotated past the pawl blocker, permitting the pawl blocker to counterclockwise rotate to its initial spring influenced position;

FIGS. 54A and 54B are first and second rotated perspectives of the package defining components corresponding to FIG. 53;

FIG. 55 is a further progression to FIG. 53 showing an initial upward reverse/return motion of the tailgate corresponding to initial contact established between the inner housing protrusion and the opposite side of the pawl blocker;

FIGS. 56A and 56B present first and second rotated perspectives of the package defining components corresponding to FIG. 55;

FIG. 57 is a further upright return progression to FIG. 55 and showing continued influencing clockwise rotation of the pawl and cinching cam by the center tooth of the sector, corresponding to continued counterclockwise rotation of the pawl blocker by the inner protuberance at a position just prior to locking of the pawl with the center/intermediate tailgate support position of the sector;

FIGS. 58A and 58B present first and second rotated perspectives of the package defining components corresponding to FIG. 57;

FIG. 59 is a further upright progression of FIG. 57 showing the pawl engaged to the middle/center position of the sector corresponding to the intermediate lock position of the tailgate;

FIGS. 60A and 60B present first and second rotated perspectives of the package defining components corresponding to FIG. 59;

FIG. 61 is a further upright progression of FIG. 59 in which the tailgate is further rotated so that the pawl is unseated from the intermediate support position of the sector;

FIGS. 62A and 62B present first and second rotated perspectives of the package defining components corresponding to FIG. 61;

FIG. 63 is a further succeeding progression to FIG. 61 and showing the pawl blocker at its maximum counter-clockwise rotation as influenced by the clockwise rotating protuberance during progressing upright rotation of the tailgate;

FIGS. 64A and 64B present first and second rotated perspectives of the package defining components corresponding to FIG. 63;

FIG. 65 is a further progression of FIG. 63, largely similar to the initial unlocked and pre-downward rotation of FIG. 43, and by which the pawl is in a pre-lock configuration which remains engaged to the sector, with the pawl blocker clearing the protuberance so that its spring bias permits it to be clockwise rotating to a neutral position, with an incremental additional upright rotation of the tailgate fully resetting the latch to the position depicted in FIG. 40;

FIGS. 66A and 66B present first and second rotated perspectives of the package defining components corresponding to FIG. 65;

FIG. 67 presents a first of a number of progression plan illustrations of the upper latch assembly of FIG. 37 with the upper housing cap removed and initially depicting the latch in an upright locked position, with each of a driving gear and driven gear, the driven gear influencing a coaxially supported upper structural cam via a nub extending into a seating aperture of the upper structural cam, which in turn actuates an upper cinch cam in engaging contact with an upper sector;

FIGS. 68A and 68B present first and second rotated perspectives of the package defining components corresponding to FIG. 67;

FIG. 69 is a progression view of FIG. 67 and showing the release lever causing clockwise rotation of the driving gear, with slaved counterclockwise rotation of the driven gear and slaved structural cam allowing for the sector to freely rotate once the release lever is fully rotated by the associated release cable;

FIGS. 70A and 70B present first and second rotated perspectives of the package defining components corresponding to FIG. 69;

FIG. 71 is a progression view of FIG. 69 and showing counterclockwise rotation of the sector corresponding to a one half travel in which the arcuate outer edge of the sector rotates freely of the structural cam and cinch cam as compared to the engaged position of FIG. 67;

FIGS. 72A and 72B present first and second rotated perspectives of the package defining components corresponding to FIG. 71;

FIG. 73 is a progression of FIG. 71 and represents a fully down position of the upper latch assembly;

FIGS. 74A and 74B present first and second rotated perspectives of the package defining components corresponding to FIG. 73;

FIG. 75 is a corresponding assembled perspective of the split tailgate supporting upper latch assembly and showing the configuration of an attachment arm which is supported about the main splined pivot, the arm being configured so that an inner facing edge contacts an outer base plate to define the fully down position;

FIG. 76 presents an illustration of a further non-limiting variant of the lower latch assembly in which the mechanism is stationary mounted between the truck bed and opposing the pivotal tailgate; and

FIG. 77 presents a further illustration of the lower latch assembly similar to FIG. 76 in which the arrangement is reversed so that the sector is stationary mounted relative to the pivotal latch components.

### DETAILED DESCRIPTION OF THE PREFERRED EMBODIMENTS

As will be subsequently described with particular reference to the updated lower latch assembly and upper split tailgate latch assembly of this continuation in part filing, and with reference to the attached illustrations, the present invention discloses a lower latch assembly for pivotally securing a tailgate to a truck bed. As described in the preceding embodiments set forth in U.S. Ser. No. 18/769,842, a package interior defining body is adapted to being secured to a side of the tailgate for enclosing each of a sector, pawl and cam. A main pivot, sector and mounting bracket are fixedly secured to an opposing side location of the tailgate, the pivot support including a rotatable portion slaved to the sector. Rotation of the cam in turn actuating the pawl to disengage from the sector, permitting in turn rotation of the tailgate.

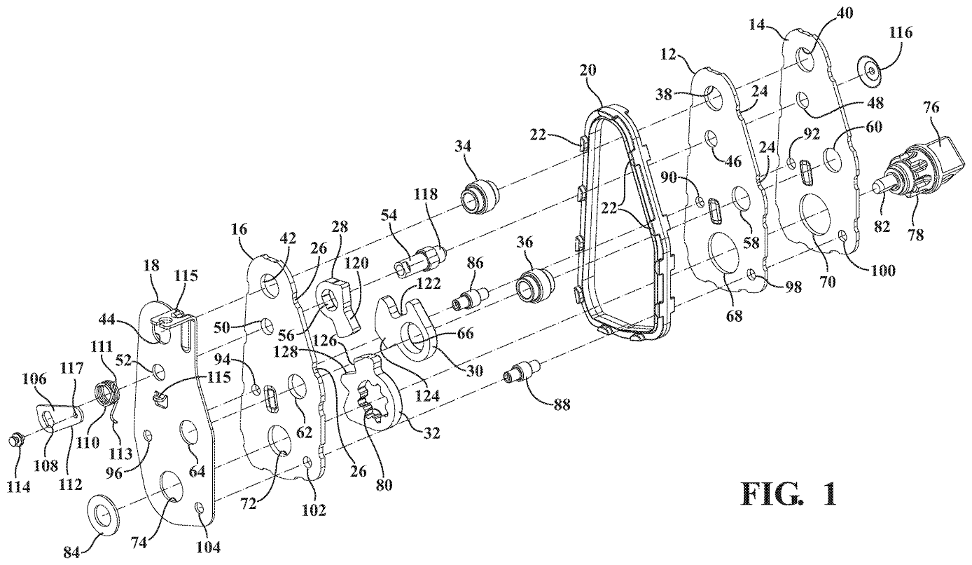

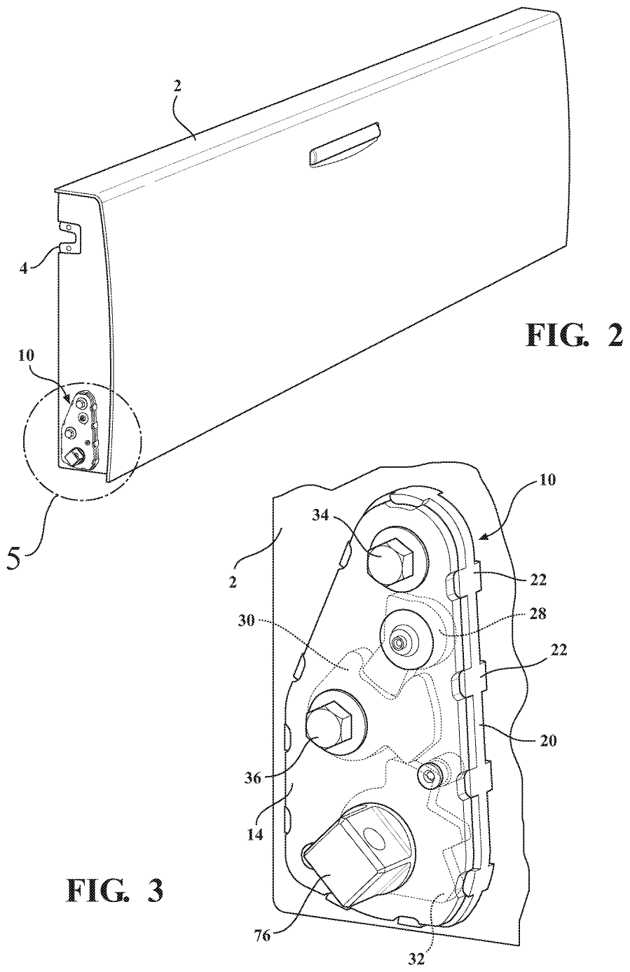

Referring to FIG. 1, in combination with succeeding views of FIGS. 2-15, an exploded view is shown of the latch assembly according to the present invention. As will be further described, the latch assembly (see as designated at 10 in FIG. 2 et seq.) is typically configured as a lower latch incorporated as a pair of such latches on opposite sides of a truck tailgate 2 (again FIG. 2 et seq.).

In combination, a pair of upper latches 4 are also positioned along the opposite sides of the tailgate 2 above the lower latch assemblies 10. The combination of the upper and lower latches along with cables extending along each side of the tailgate and opposing truck bed operate to support the tailgate in the fully downwardly pivoted open position.

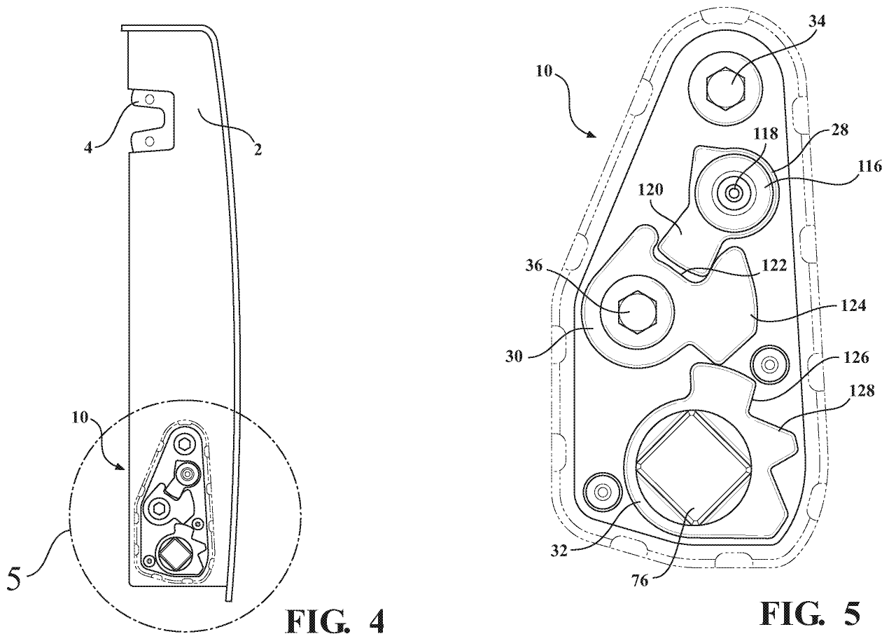

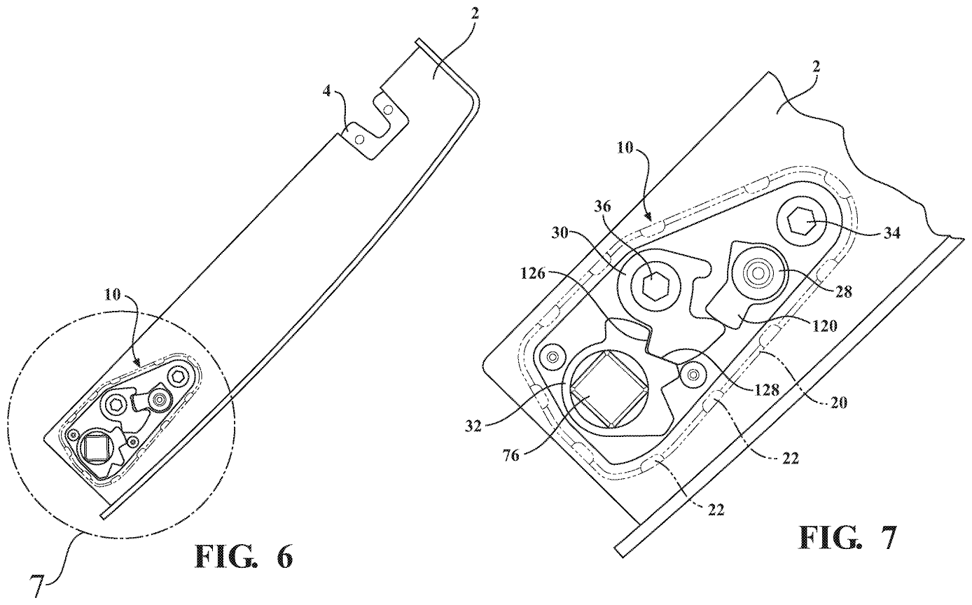

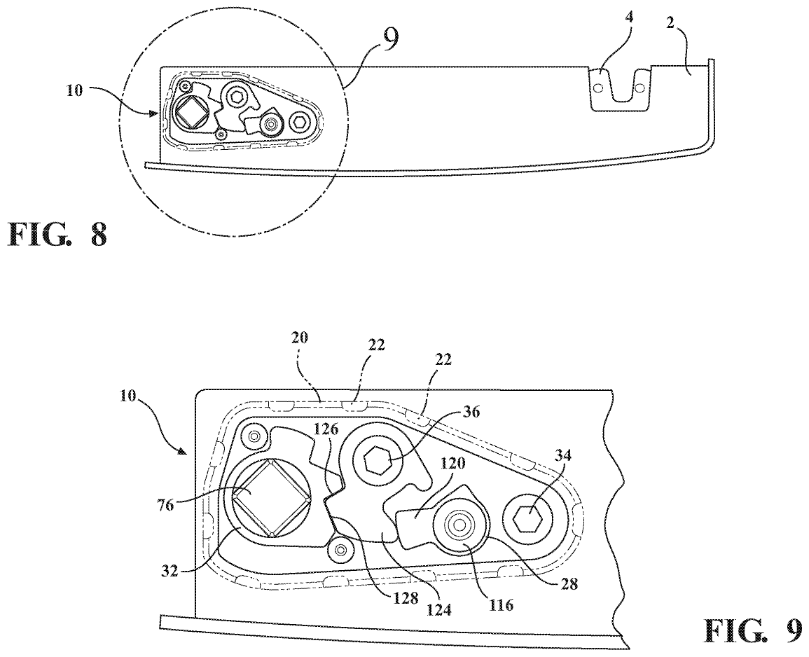

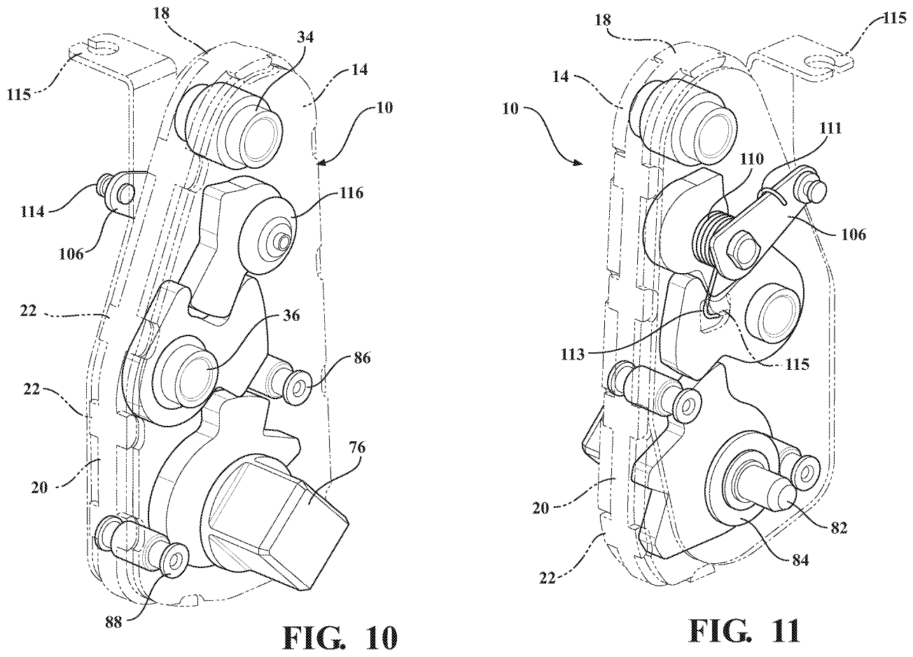

As will be further described, the pair of opposite lower latch assemblies 10 allow for the tailgate to be adjusted between each of a fully upright/closed position (FIG. 4), an intermediate angled, such as 45°, position (FIG. 6) and a fully downwardly rotated and horizontal open tailgate position (FIG. 8). Although not shown, it is understood that that the pawl and sector can be redesigned, such as by adding teeth, in order to accommodate multiple intermediate positions. The ability to establish an intermediate locked position of the tailgate allows for safer and effective securing of items longer than a horizontal length of the truck bed (not shown) to which the tailgate is pivotally secured.

Referring again to FIG. 1, an exploded view is shown of a non-limiting arrangement of components constructing the lower latch assembly 10. A plural arrangement of package defining plates includes each of a pair of rear or inner plates 12 and 14 and an opposing pair or forward or outer plates 16 and 18. Without limitation, the latch assembly also envisions the use of a single plate on either side of package interior components.

An outer gasket or seal 20 is arranged between the pairs of inner and outer plates and which at least overlaps and seals around the inward positioned pair of opposing plates 12 and 16 (see as best shown in FIGS. 10-11) in order to environmentally seal the package interior. As is further best shown in FIG. 2, the seal 20 includes a plurality of perimeter spaced lateral protuberances 22 which align with and resistively engage over notches (at 24 and 26 respectively) associated with the inward opposing plates 12 and 16.

The package defining interior established between the plates 12/14 and 16/18 supports each of a cam 28, pawl 30 and sector 32. A pair of structural supporting bushings 34 and 36 are also provided within the package space, with the lower positioned bushing 36 (which can be without limitation substituted by a rivet) defining pivotal support for the pawl 30.

A plurality of interior rim defining apertures are formed in the package defining plates 12/14 and 16/18 for supporting the various internal components, and includes as shown at 38/40 and 42/44 configured in alignment through the plates 12/14 and 16/18 for supporting the upper bushing 34. Additional aligning apertures are shown at 46/48 and 50/52 for receiving a cam pivot pin having a keyed shaft 54 for seating through a mating keyed interior 56 of the cam 28.

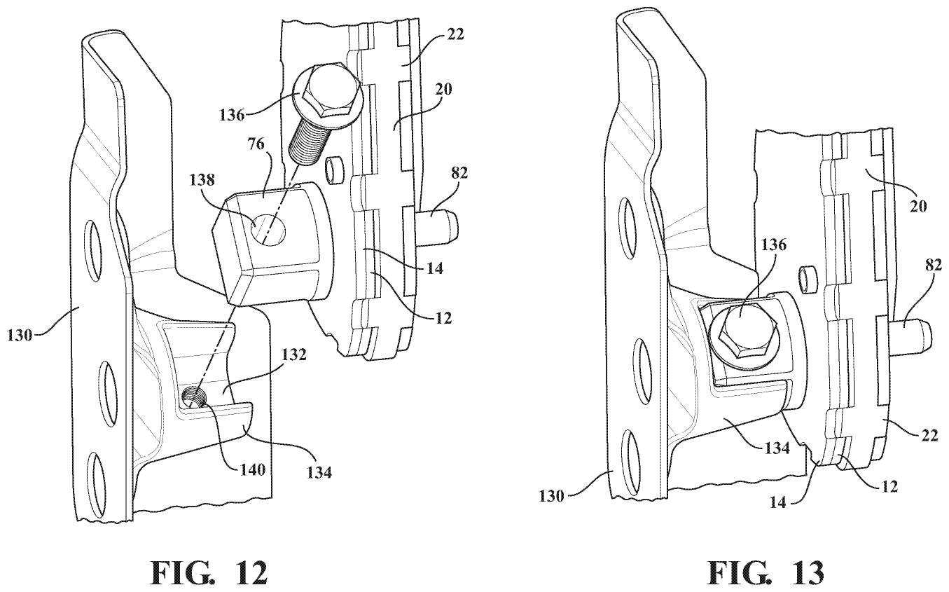

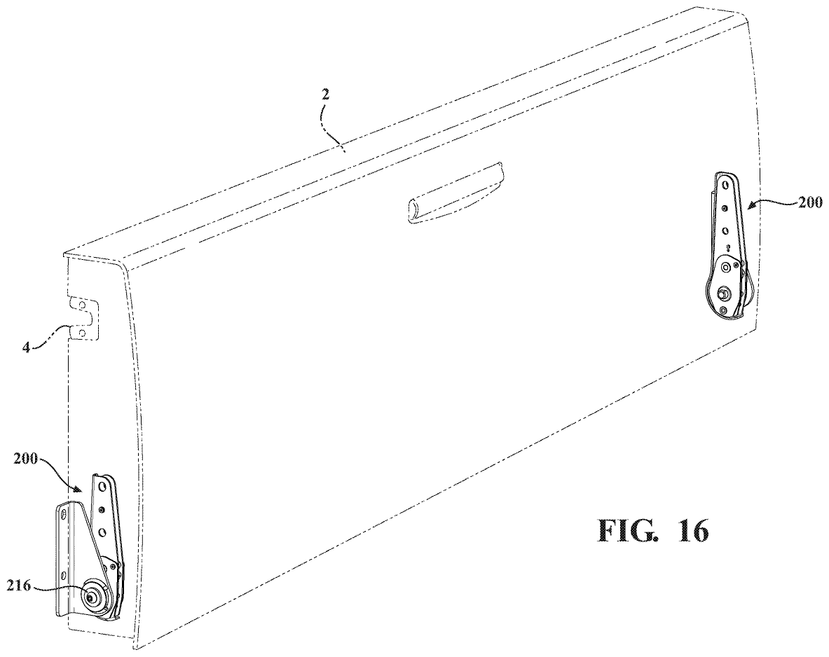

Pairs of aligning apertures 58/60 and 62/64 seat the lower bushing 36, which in turn again rotatably supports the pawl 30 via an interior rim defining aperture 66. Further aligning pairs of apertures 68/70 and 72/74 seat a main pivot support having a square shaped hub 76 (which as will be further described in reference to FIG. 12 is affixed to a supporting bracket of the truck bed), with the main pivot support further having a circular keyed bearing portion 78, this also generally understood to be a splined portion as depicted in the related embodiment of FIG. 16 et seq.

The sector 32 further exhibits a keyed interior 80, which seats the keyed bearing portion 78 of the pivot support. An end most tenon portion 82 of the main pivot support sets through the outermost aligning aperture 74 and over which is installed a washer 84. As described in FIG. 11, the tenon 82 exhibits a “D” shaped cross section and attaches to a torsional spring (not shown) which is located inside of the liftgate for inducing a lift assisting torque to the tailgate. Without limitation, the keyed portion 78 can be substituted by a spline configuration (see FIG. 16 et. seq.) which can interface with either of a motor assembly or damper component.

A pair of rivets 86 and 88 are also shown which seat through further aligning sets of apertures 90/92 and 94/96 and at 98/100 and 102/104 for providing structural support to the package assembly. The lower positioned rivet 88 also serves as a limiting stop to ensure that the tailgate does not over rotate when in the down position. A release lever 106 has a keyed aperture 108 for receiving the cam pivot pin keyed shaft 54. One or more torsional springs, see at 110, are positioned at right and left handed sides of the latch assembly for biasing the release lever 106 in a clockwise direction as depicted at 112 in FIG. 1. As further shown in each of FIGS. 1 and 11, extending legs 111 and 113 of the torsional spring 110 respectively engage to each of the release lever 106 and a stamped projection 115 in the plate 18.

In the instance of a cabled system, a cable rivet 114 attaches to an aperture 117 located at an end of the release lever 106. In the instance of a link rod configuration and as further depicted in FIG. 11, the cable rivet is removed and a link rod (not shown) is substituted to engage within the aperture 117 where the cable rivet would otherwise be installed. A plastic clip typically is inserted into the aperture 117 prior to installation of the link rod in order to prevent instances of buzz, squeak and rattle (BSR) during operation of the latch assembly. In the up position, the upper latches 4 only are locked whereas, in the intermediate and lowered positions only the lower latches 10 are locked. Also shown is attachment bracket portion 115 configured in plate 18, routed inside of the vehicle tailgate for actuating the assembly when the handle on the rear of the tailgate is pulled or otherwise actuated. Also shown is a cam washer 116 supported against and outer face of the inner most plate 14 for seating an innermost projection 118 of the cam keyed shaft 54.

Referring now to FIG. 2, presented is an environmental perspective view of a tailgate incorporating the latch assembly 10 of the present invention as a lower tailgate latch in combination with the upper latch (symbolically again represented at 4), these again being arranged on each of opposite sides of the tailgate for securing the same to opposing locations of the surrounding truck bed.

FIG. 3 presents an enlargement of the latch assembly of FIG. 2, and depicting selected package defining plates (see at 14) in partially transparent fashion to better illustrate the cam 28, pawl 30 and sector 32 components.

FIG. 4 presents a plan side view of the tailgate 2 in an upright vertical position with the lower latch assembly 10 unlocked and the upper latch 4 locked. FIG. 5 presents an enlargement of the lower latch assembly in FIG. 4 and again showing the cam 28, pawl 30 and sector 32 components in the unlocked position. In this position, a projection 120 of the cam 28 is seated within an opposing pocket recess 122 in the pawl 30. As further shown, a configured projection 124 of the pawl 30 in FIG. 5 is rotated out of engagement with the sector 32, allowing it and the tailgate to rotated (via the circular keyed bearing portion 78 seating the keyed interior 80 of the sector) relative to the hub 76 affixed to the truck bed supported bracket.

FIG. 6 presents a succeeding view to FIG. 4 and depicts the truck tailgate rotated to an intermediate forty five degree position, at which the lower latch 10 is re-engaged to secure the tailgate in position. FIG. 7 is an enlargement of the lower latch assembly of FIG. 6 and depicting the lower latch re-engaged at the intermediate tailgate position, and which is depicted by pawl projection 124 being rotated (via actuation of the cam 28 and its projection 120) into engagement with an opposing and seating interface of the sector 32, which is further referenced by generally normal or perpendicular angled surfaces 126 and 128. In this position, rotation of the sector 32 is constrained by the pawl 30 and pressing force exerted by the cam projection 120.

FIG. 8 presents a further succeeding view to FIG. 6 and depicting the truck tailgate 2 in a fully downwardly rotated horizontal position at which the lower latch assembly is re-engaged. FIG. 9 is an enlargement of the lower latch assembly in FIG. 8 depicting the lower latch in the re-engaged position, with the cam 28, pawl 30 and sector 32 in the arrangement previously described in the intermediate rotated position of FIG. 7.

FIG. 10 provides a perspective view of the tailgate and further illustrating the latch-to-tailgate mounting bushings 35 and 36 as well as the rubber or elastomer seal 20 extending around the perimeter of the assembly in order to protect the internal components of the latch from external contaminants and objects, the presence of which could inhibit operation of the locking mechanism.

FIG. 11 is a one-hundred and eighty degree rotated view of FIG. 10 and depicting the release cable or link rod system as previously described, which can be routed inside the tailgate for simultaneously releasing the upper and lower latches when the handle on the back of the tailgate is pulled, as well as depicting a “D” shaped tenon (see again at 82) which attaches to a torsional spring located inside of the liftgate for inducing a torque to assist lifting of the tailgate.

FIG. 12 is an exploded view depicting the pivotally supported attachment of the lower latch assembly to the opposing side edge of the truck bed (see as referenced by body 130). Brackets are provided which include square shaped cavities 132 formed in a seating receptacle 134 configured on an opposing inside face of each bracket mounted to the truck body 130 on both sides of the tailgate 2. The brackets 132/134 receive the mating hubs 76 of the main pivot body of the lower latch, with screws 136 installed through aligning apertures 138 and 140 (see as interiorly threaded) for engaging the hubs 76 within the cavities 132.

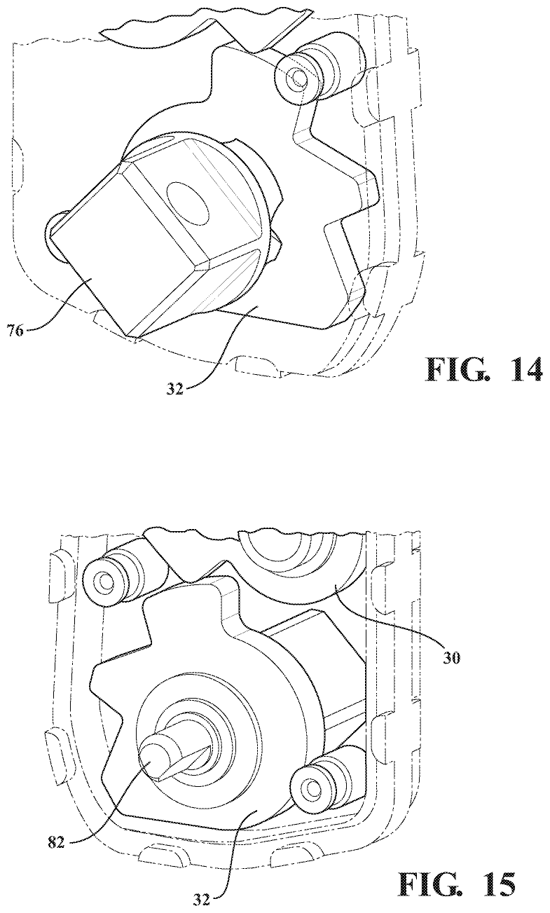

FIG. 13 is a succeeding assembled view of FIG. 12, with FIG. 14 further providing a lower sectional view of the latch assembly, after being mounted to the vehicle bed, and depicting the sector and main pivot pin being fixed. FIG. 15 succeeds FIG. 14 and depicts the latch and tailgate rotating round the fixed sector 32 and fixed portion of the main pivot.

Referring now to FIG. 16, presented is an environmental perspective view of a tailgate, see again as referenced at 2, incorporating the latch assembly, see generally at 200, according to a further embodiment of the present invention and which again includes a lower tailgate latch in combination with an upper tailgate latch (see again as represented at 4), and which are arranged on each of opposite sides of the tailgate 2 for securing the same to opposing locations of the surrounding truck bed. As previously described in reference to the latch assembly 10 in FIG. 2, the upper latches 4 are present when the cable version is utilized, with the lower latches 10 alone substituting for the cables for supporting the tailgate in the fully downwardly pivoted open position.

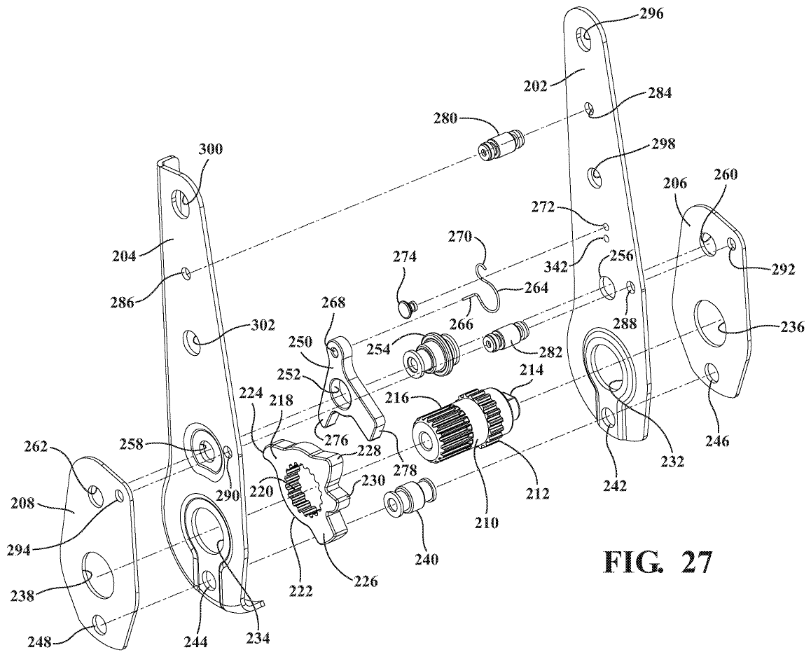

FIG. 27 presents an exploded view of a selected latch assembly 200 according to the embodiment of FIG. 16 et. seq. of the present invention and includes an inner plate 202 and an outer plate 204. The package defining structure of the latch can also include outermost doubler plates, see innermost doubler plate 206 and outer most doubler plate 208 which are secured to the outer faces of each of the inner 202 and outer 204 plates.

A main pivot 210 is provided and includes an intermediate exteriorly toothed or splined portion 212 (such engaging through the redesigned sector as will be further described) along with an end configured “D” shaped profile 214. Also shown is an end-most located geared or splined profile 216 (opposite the “D” profile) which can be engaged by a rotational output of a motor (not shown) in an optional powered variant.

The sector is depicted at 218 and includes an interiorly geared profile 220 through which the main pivot 210 extends so that the intermediate splined portion 212 is seated in alignment within the interior profile 220 (see as shown in FIG. 19). The sector 218 includes an arcuate extending exterior portion 222 communicating with spaced apart and radial projecting portions 224 and 226. Additional radial projecting and pawl engaging locations 228 and 230 are designed into the remaining outer circumference of the sector 218.

The main pivot 210 seats through aligning main pivot apertures are configured at 232 and 234 into the inner 202 and outer 204 package defining plates, along with additional apertures 236/238 in the outer most secured doubler plates 206/208. A stop rivet 240 secures to additional aligning apertures 242/244 in the plates 202/204, along with additional aligning apertures 246/248 in the outer doubler plates 206/208, such that the stop rivet is positioned in proximity to the arcuate extending portion 222 of the sector 218 so that the sector exhibits a range of rotation until the stop rivet 240 contacts either of the radial projecting portions 224/226.

A pawl 250 includes a central aperture 252 through which is seated a pawl pivot rivet 254 which in turn seats through aligning apertures 256/258 in the plates 202/204, along with corresponding apertures 260/262 in the outermost doubler plates 206/208. Alternatively, a curved omega spring 264 (which can be provided as a pair of springs 264) is provided for each latch assembly and which includes a first straight extending end 266 which seats through an upper end located aperture 268 in the pawl 250, along with a second curved extending end 270 which aligns with an aperture 272 configured in the inner package defining plate 202 and is retained in place by a spring securing rivet 274. Also shown is a lower proximate aperture (see as further shown at 342 in FIG. 29) which can be alternatively provided for engaging the corresponding end 270 of the spring 264 without use of the rivet 274. The pawl 250 further depicts first 276 and second 278 portions projecting from an end opposite the upper end aperture 268 so that rotation of the pawl 250 about the central aperture 252 results in the pawl 250 contacting the sector 218 at specific positions.

A pair of rivets 280 and 282 engage respective pairs of securing apertures 284/286 and 288/290 in the inner 202 and outer 204 plates, with additional aligning and overlapping apertures 292/294 in the doubler plates 206/208 providing structural support to the package assembly. Finally, pairs of holes or bushings are referenced at 296/298 and 300/302 for each of the inner 202 and outer 204 plates for mounting the hinge latch assembly to the opposing supporting sides of the tailgate 2.

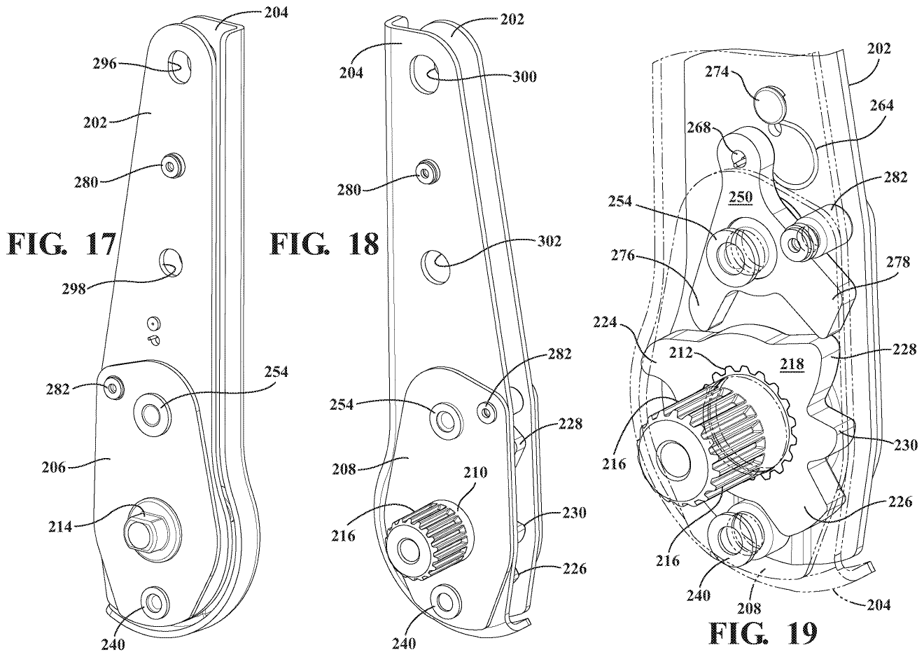

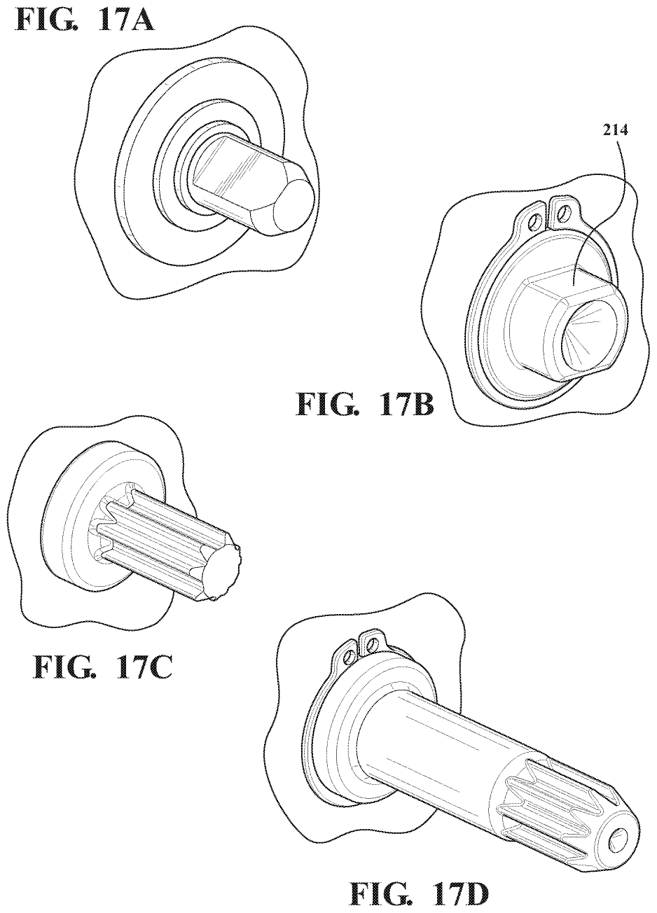

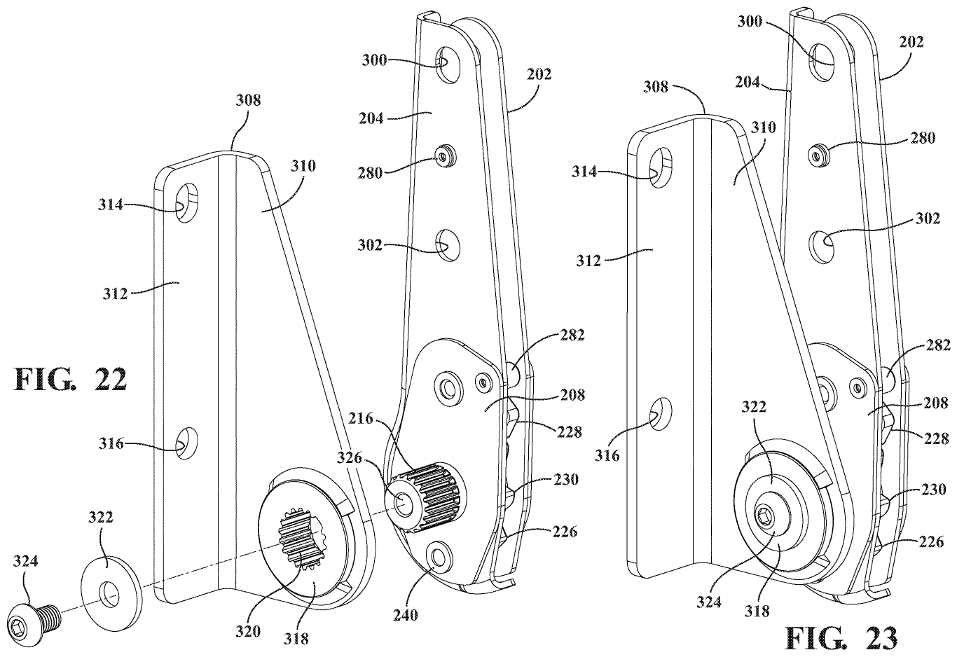

Referring now to FIG. 17, a first perspective view is shown of tailgate hinge latch assembly of FIG. 16 and depicting each of the upper holes or bushings, again 296/298 and 300/302 for mounting the hinge latch assembly 200 to the tailgate 2, in combination with the double “D” 214 and spline 216, such operable in a variety of variants for interfacing with each of a motor associated with an optional powered variant, a damper component for slowing rotational descent/drop of the tailgate, or the lift assist spring component (again at 264). As understood, the larger external spline 216 (or alternatively the square shaped hub 76 as depicted in latch embodiment 10) is only used to mount to the truck bed (via the mounting bracket sub-assembly or other means such as which is depicted in subsequent FIG. 22). The end of the main pivot 210 opposite the big spline 216 can exhibit any of a “D” shaped profile (see FIG. 17A), double D or “DD” profile (FIG. 17B) (again at 214 in FIG. 17)) or a smaller diameter spline (see alternate versions shown in FIGS. 17C and 17D) and which interfaces with any of a torsional spring, damper, or electric motor (via its output shaft). Additionally the outboard side of a latch can exhibit either a square hub or large spline, with the inboard side of the latch exhibiting any of a DD shape, a single D (small diameter), or a smaller spline shape.

FIG. 18 presents a one hundred and eighty degree rotated view of the latch assembly of FIG. 17 and depicting spline configuration 216 of the main pivot 210. FIG. 19 presents a partially transparent view of latch assembly of FIG. 16 and depicting a variation of the ratchet mechanism in which the redesigned pawl 250 incorporating the over center spring 264, with the external spline pattern 216 again shown which operates as a generic connector that allows for accommodating a variety of truck body mounting scenarios.

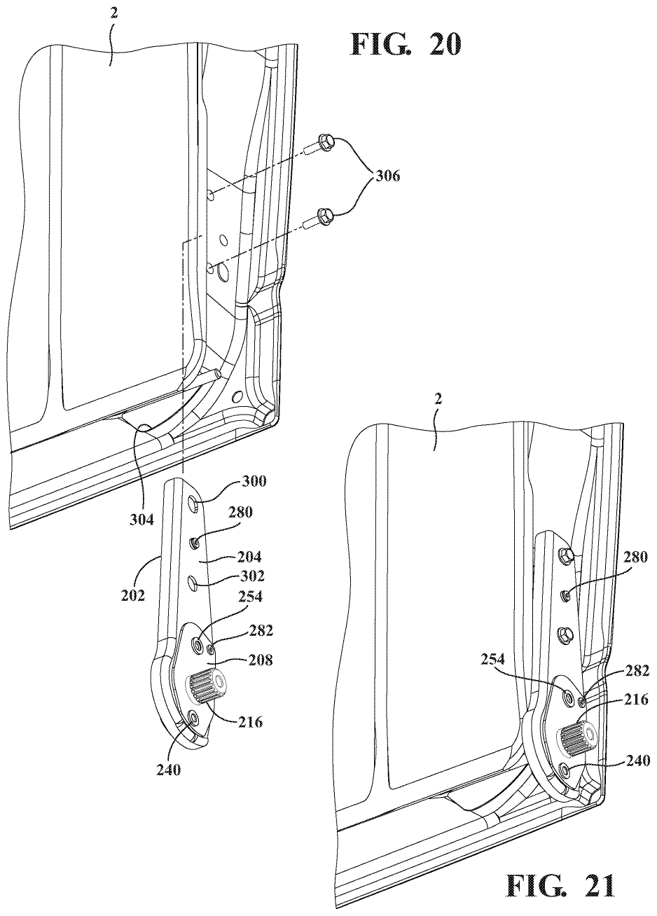

FIG. 20 presents an exploded view of the latch assembly with alternate mounting options relative to the tailgate 2 and which, in a first instance, can include being inserted into a bottom corner facing aperture (see inner perimeter defining rim edge 304) of the tailgate 2 for providing an internal mounting option, and so that the spline 216 projects downwardly. Bolts 306 are provided for securing the latch assembly in place (via aligning pairs of apertures 300/302 and 296/298 in plates 204 and 202). FIG. 21 illustrates an assembled view of a further mounting variant in which the latch assembly is mounted to the outside surface of the tailgate depicted in FIG. 20. The present invention contemplates any of interior or exterior tailgate mounting configurations for the latch assembly.

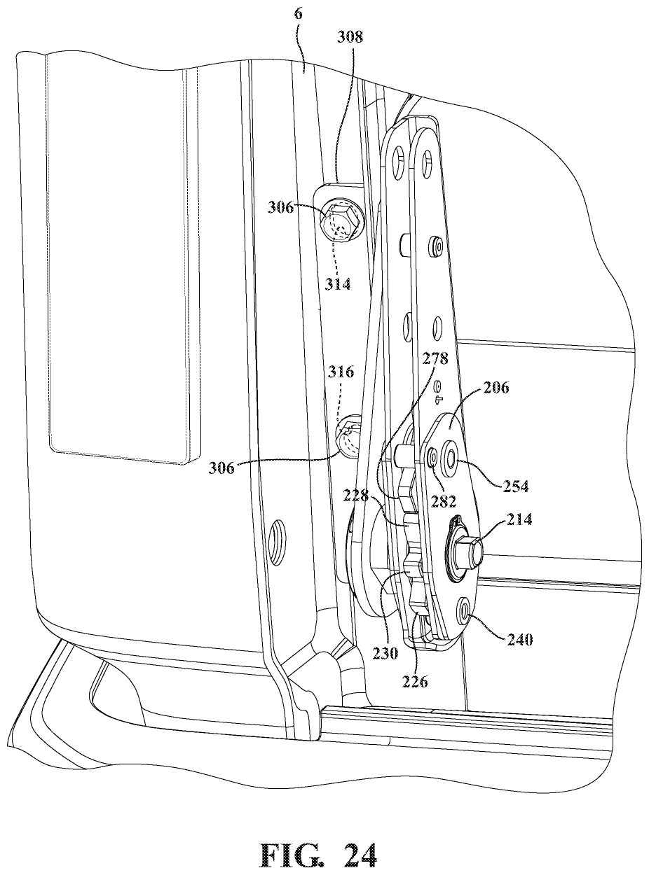

Proceeding now to FIGS. 22-24, presented are a series of exploded, assembled and environmental installed view of the latch assembly and including supporting mounting brackets 308, a pair of which are provided and mounted to rear facing locations of the truck bed 6 opposing the tailgate 2. Without limitation, the supporting bracket 308 exhibits an angled shape with a first latch support side 310 and a second mounting side 312, the second side having bolt receiving holes 314/316 for mounting to the truck bed. Also shown are the mounting bolts 306 previously identified in FIG. 20 and arrayed in the further mounting configuration shown.

The latch support side 310 of the bracket further incorporates a lower spline mount 318 exhibiting an inner aperture spline pattern 320 which receives the spline 216 of the main pivot 210. A washer 322 and attachment screw 324 are provided for securing the spline 216 (via an exposed threaded interior aperture 326)

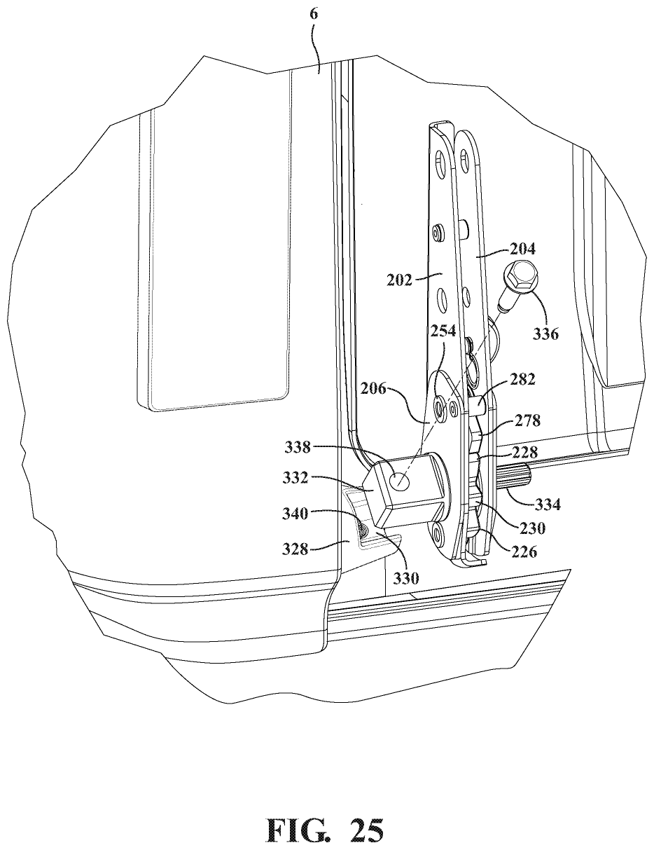

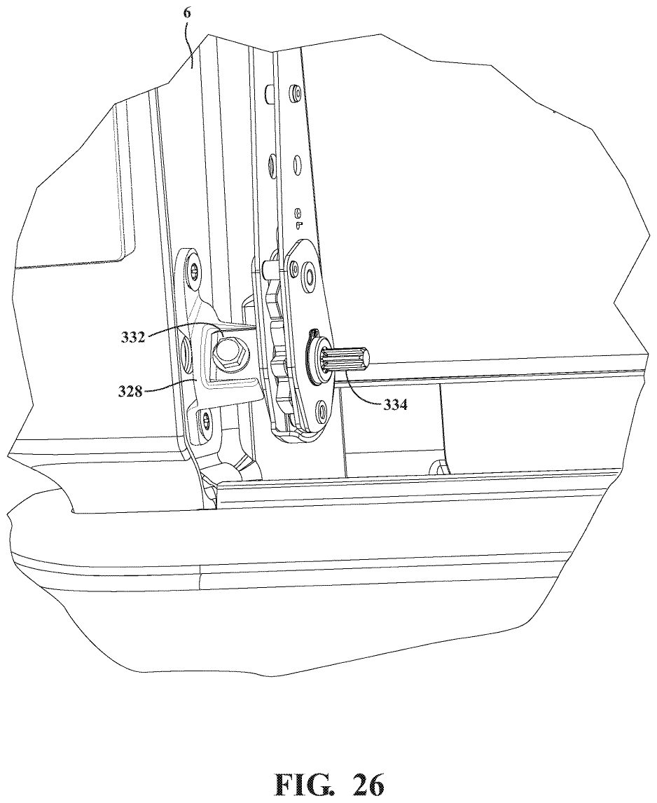

FIGS. 25-26 depict a pair of exploded and assembled environmental view of the tailgate latch assembly according to the present invention, which is installed in rotationally supporting fashion to each of opposing side locations of the truck bed, again at 6, according to an existing configuration of support bracket. This is further depicted by casting 328 which exhibits a contoured pocket 330 for receiving a reconfigured square shaped mounting hub 332 configuration of a main pivot. Also shown is a square hub 334 (see as compared to spline previously depicted in 216 in FIG. 27) which can be alternatively utilized for mounting to the vehicle for interfacing with any of a motor, damper or torsion bar spring, according to a variety of alternate configurations of the present assembly. A fastener 336 mounts the square shaped hub 332, via an internal aperture 338, which rotationally engages an interiorly threaded aperture 340 configured in the casting pocket 330 in order to mount the latch assembly.

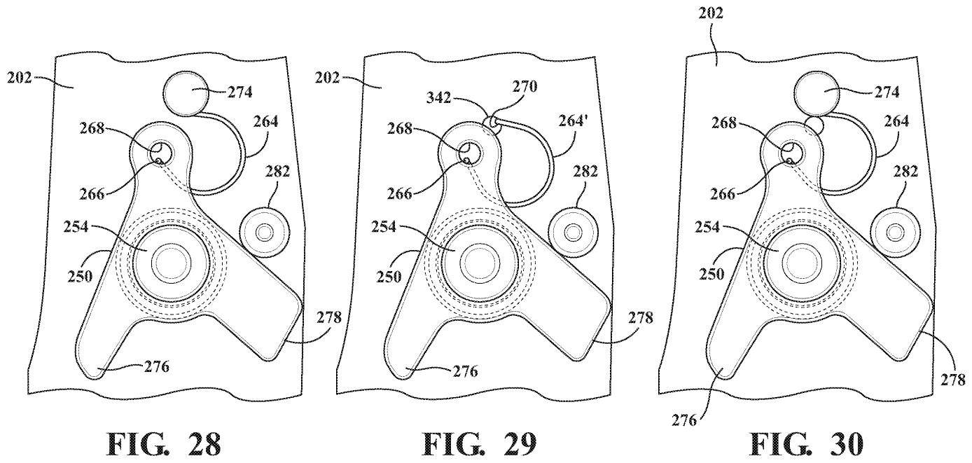

Proceeding to FIGS. 28-30, presented are a series of sectional views of the pawl component 250 rotationally mounted between the inner and outer support plates (202/204), respectively via each of an omega spring (again at 264) and rivet 274 as shown in FIG. 28. As shown in FIG. 29, aperture 342 is configured in the inner plate 202 for receiving the end 270 of differently modified spring, see at 264′, without the use of the spring rivet 274. As further shown in FIG. 30, the spring configuration 264 of FIG. 28 provides the desired bias to the pawl 250 between the various positions established by the latch assembly.

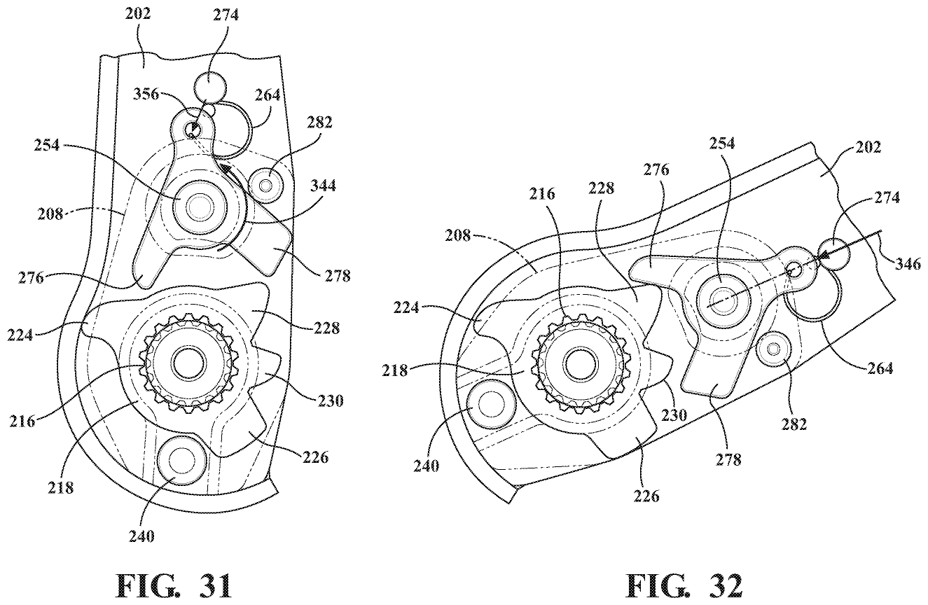

With reference now to remaining FIGS. 31-36, a series of sequential views are shown of the downward and return upright positions of the latch assembly pawl 250 and sector 218 components, which includes FIGS. 31 and 36 respectively and identically depicting each of initial and return upright positions. FIG. 31 presents a lower sectional view of the tailgate latch in the upright position in which the pawl 250 is depicted in an open/disengaged position, resulting from an exerted force from the spring 264 on the pawl resulting in a counterclockwise torque exerted by the pawl (see at 344) so that the first 276 and second 278 projecting portions of the pawl are not contacted by the spaced apart and radial projecting portions 224 and 228 of the sector as the tailgate 2 is free to rotate downwardly.

FIG. 32 presents a similar view to FIG. 31 and depicting the tailgate latch in an intermediate pivoted threshold position (which in the illustrated embodiment is shown at 60.9° relative to a vertical axis extending through a centerline of the main pivot 210, at which there is no torque exerted on the pawl 250 from the spring 264, and beyond which continued downward rotation of the tailgate 2 causes a reverse torque to be exerted on the pawl. As further depicted, a linear force extending through the pawl (see directional arrow 346 extending across centerline aperture 252 of the pawl).

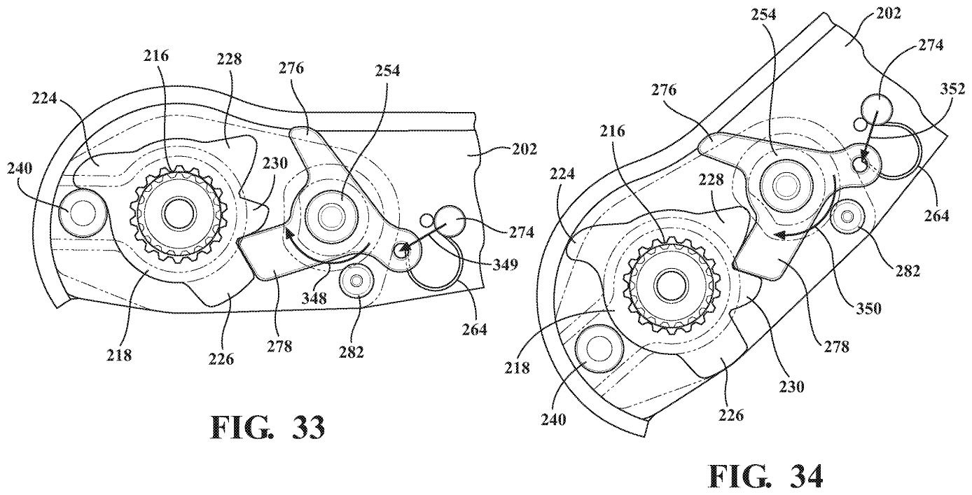

FIG. 33 presents a further succeeding view of the tailgate in a down position (generally illustrated at 87° relative to the vertical axis extending through the main pivot) at which the pawl is in the lock position, depicted by its projecting portion 278 sandwiched between the opposing and circumferentially offset projecting portions 226 and 230 of the sector along with the further projecting portion 224 rotated into engagement with the stop rivet 240. At this point, a clockwise exerted torque (see directional arrow 348) is exerted by the spring 264 on the pawl, in combination with a separate linear directed force shown at 349, at which point the tailgate 2 is free to rotate in a return upright fashion.

FIG. 34 succeeds FIG. 33 and depicts an upwardly intermediate returning location of the tailgate latch (approximately 45° between either of horizontal or vertical axes extending through the main pivot). Upward rotation of the latch is exhibited by clockwise directional arrow 350 (similar to as shown at 348 in FIG. 33) which is facilitated by linear force exerted by the spring on the pawl (referenced by arrow 352 and as compared to as shown at 349 in FIG. 33) extending generally between the spring retaining rivet 274 and the upper end located aperture 268.

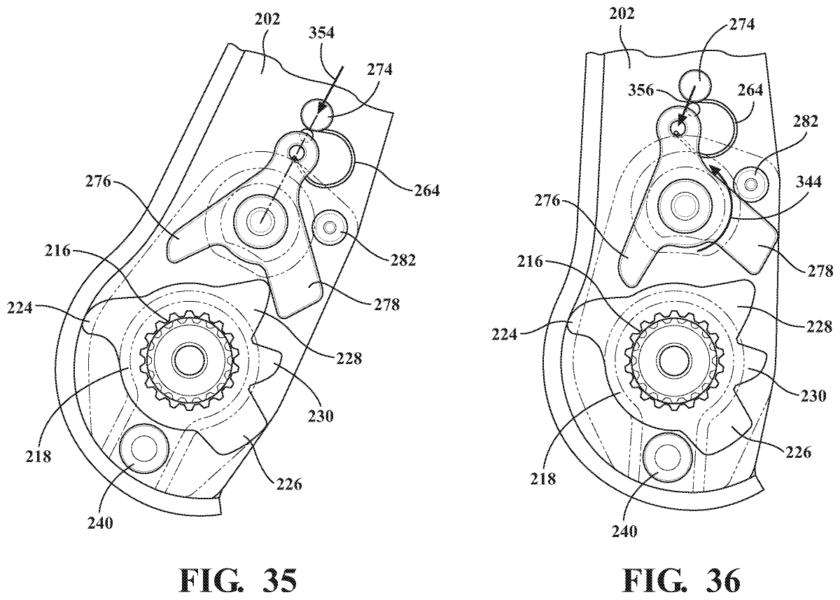

FIG. 35 succeeds FIG. 34 and depicts the pawl in a further upwardly rotated threshold position, with the torque from the spring 264 exerted on the pawl removed, and at which continued upright rotation of the tailgate 2 results in the torque on the pawl to be reversed. A generally linear force (see directional arrow 354) is exerted by the spring 264 through a general centerline of the pawl with the pawl rotating in a counterclockwise direction (see directional arrow 355) relative to the fixed sector.

FIG. 36 further depicts the tailgate in the returned upright position identical to that previously described in FIG. 31 at which the pawl is in the open/disengaged position and the tailgate is again free to rotate downwardly until stopping against the truck body in the opposite direction. This is again referenced by the counterclockwise torque (directional arrow 344) on the pawl as influenced by the linear offset force of the spring 264 (see further arrow 356).

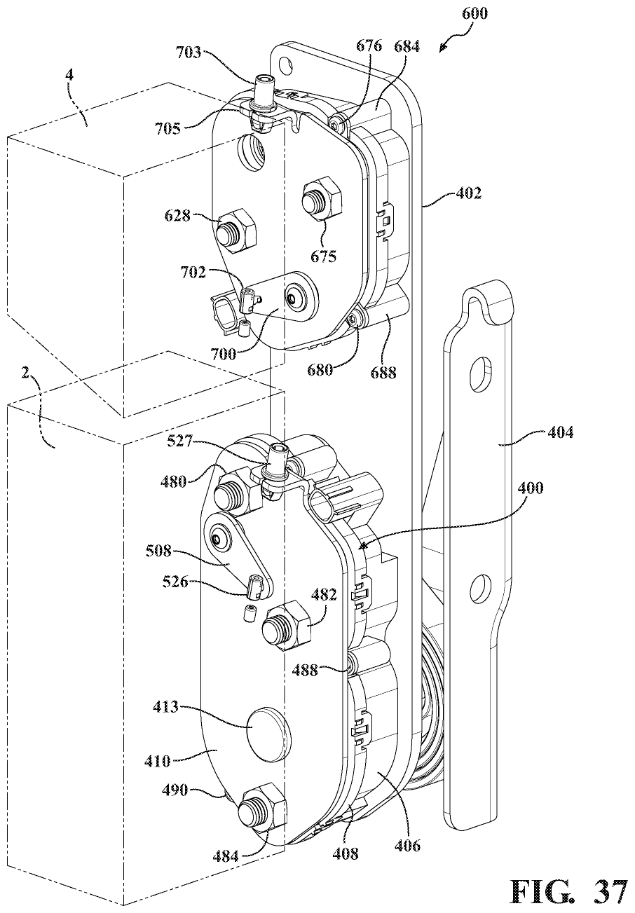

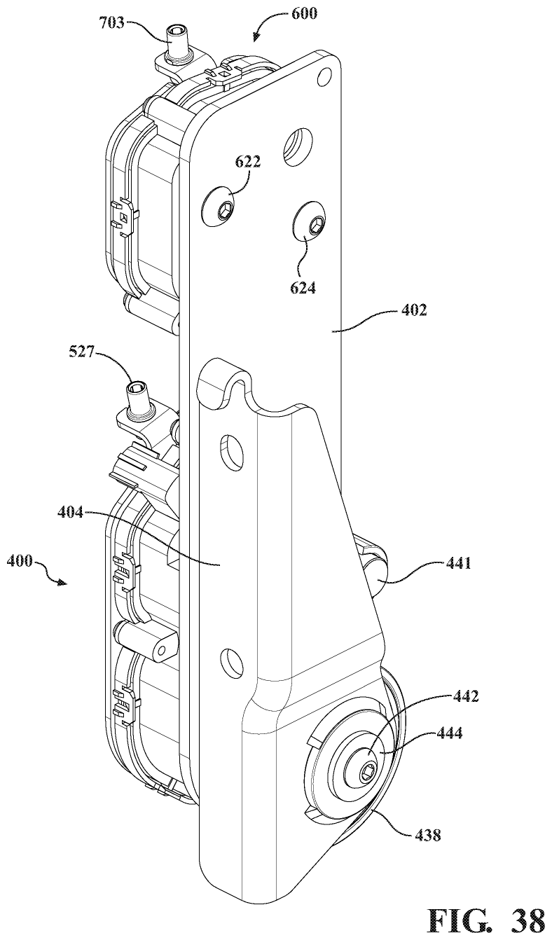

Proceeding to FIG. 37, a frontal perspective is provided generally of a lower latch assembly 400, shown in combination with a separate and upper split tailgate latch assembly 600 according to a further embodiment of the present invention, with FIG. 38 providing a rotated rear looking perspective of FIG. 37.

As will be further described, the lower tailgate latch assembly 400 represents a non-limiting embodiment to the lower latch assemblies previously illustrated and described at 10 in FIG. 2 and at 200 in FIG. 16. The upper latch assembly 600 is also provided for operating an upper split-tailgate portion of the truck tailgate and can be operated either in combination with any of the lower latch assemblies 10, 200 or 400 or can be provided with any other lower latch design outside of that described. Reciprocally, the lower latch assembly 400 can be provided individually without the upper latch assembly 600, similar to as shown and described in the previous embodiments 10 and 200.

FIGS. 37 and 38 representatively illustrate a support plate 402 for securing both the lower latch 400 and upper latch 600 subassemblies, a mounting bracket 404 integrated into the support plate 402 for mounting to a left side of the rear truck bed for securing the truck tailgate. As further representatively shown in FIG. 37, the lower latch 400 operates to rotate a main lower width extending tailgate portion (see representatively at 2), with the upper latch 600 in turn individually operating an upper split tailgate portion (further at 4) which can further pivot relative to the common support plate 402.

Without limitation, a complementary right side assembly, being a mirror image thereof to FIG. 37, is envisioned and can be provided on an opposing right side of the vehicle truck bed and tailgate. Alternatively, the latches 400 and 600 can be provided individually on one side of the tailgate to truck bed interface, with any simplified latch arrangement with common pivot support located on the opposite side.

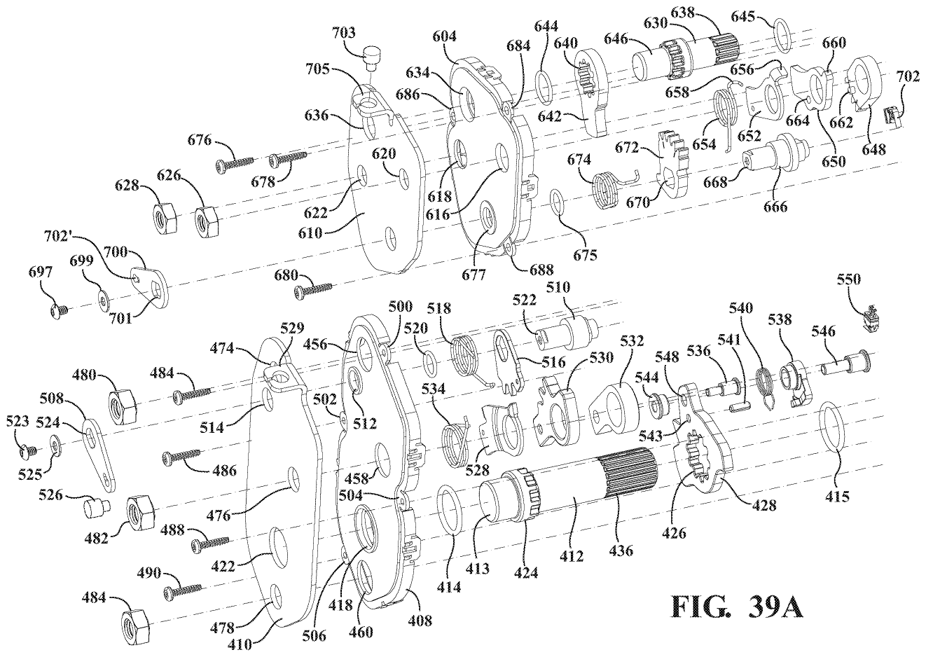

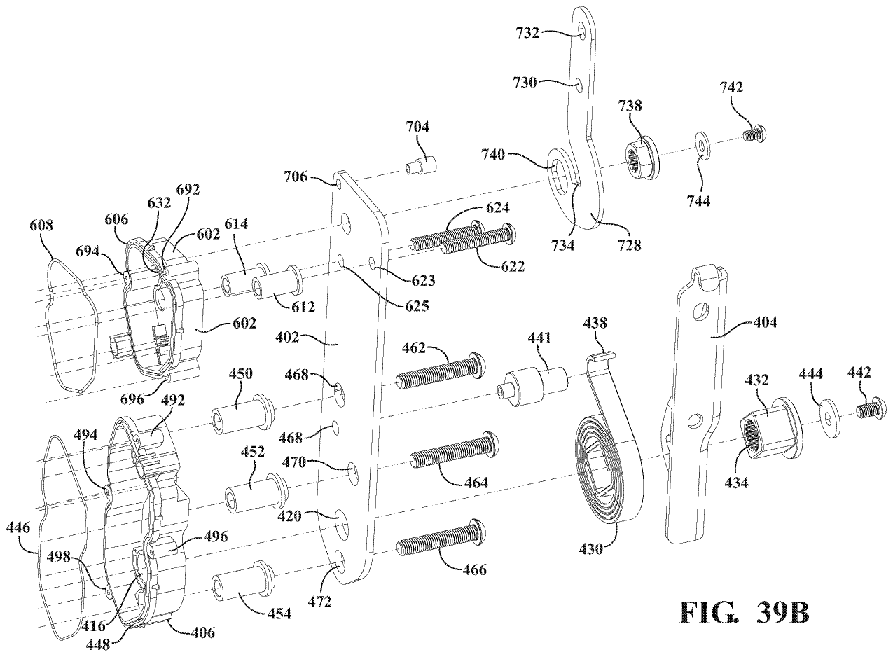

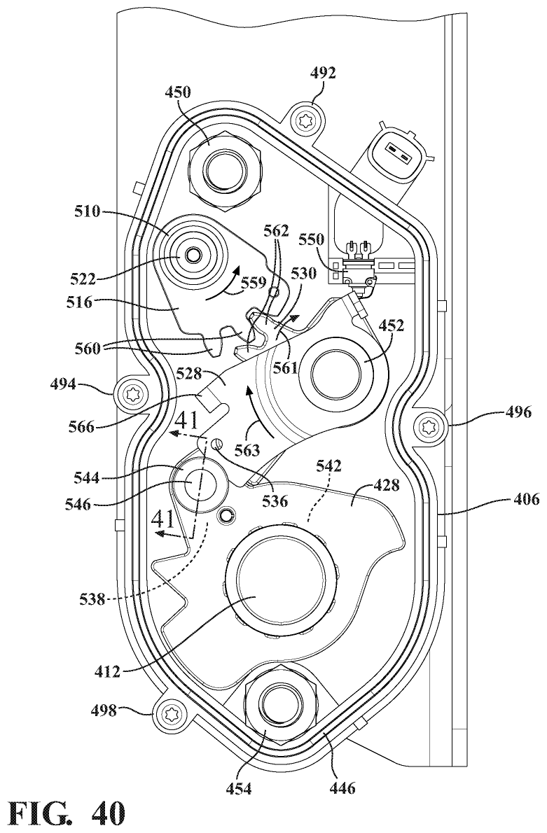

FIGS. 39A-39B collectively present an exploded view of the combination assembly depicting each of the lower 400 and upper 600 latch assemblies of FIGS. 37-38, with FIGS. 40-54 providing a series of progression views of the functionality of the lower latch assembly 400 for pivoting the tailgate between each of the upright, intermediate and down positions. Successive views 55-75 provide a corresponding description of the functionality of the upper latch assembly 600 for separately actuating the split upper tailgate, typically between upright and downward ninety degree rotated positions.

A callout of all of the lower and upper latch features will be provided in the exploded view of FIGS. 39A-39B, and prior to description of the progression functionality of each of the lower 400 and upper 600 latches, with reference being made interchangeably to each of these views in combination with the callout of the features comprehensively depicted. With further respect to the lower tailgate latch 400, it is noted that the design permits the tailgate portions 2 and 4 to be rotated fully downward upon actuating the cable release, and without the requirement of holding the release latch. As will be also further described an additional notable feature of the lower latch 400 is the ability to rotated the tailgate 2/4 downwardly past the intermediate support location, with the ability to then reverse rotate the tailgate upwardly and have the latch engage the support at the intermediate location.

Addressing the lower latch components which are again depicted collectively in FIGS. 39A-39B, a lower package interior defining housing is provided by a main or base housing 406, with an assemble-able upper housing or cap housing 408. The base housing 406 and cap housing 408 are constructed without limitation from a durable plastic, with an inner plate 410 providing additional support for sandwiching the housing between the outer support plate 402. The plates 402/410 and the remaining package interior components can further be constructed of a desired grade steel or similar metal.

A main pivot pin 412 (also termed a lower main pivot in combination with an upper main pivot associated with the upper latch assembly 600 as will be further described) is provided along with a pair of main pivot O-rings 414/415 extending between apertures 416 and 418 formed respectively in the main housing 406 and cap 408, as well as with additional aligning apertures at 420 in the support plate 402 and at 422 in the sandwiching inner plate 410. The main pivot 412 includes an annular raised portion including a toothed exterior 424 which seats within a mating toothed interior aperture defining profile 426 of a sector 428 which is in turn fixedly secured to the truck bed. As further previously described, the main pivot 412 can further incorporate an end-configured “D” shape or double “D” profile, shown at 413, and which further changes to a spline for engaging with a motor or radial dampener (not shown).

The remaining package defining components and supporting assembly, including the support plates 402/422 on opposite sides of the package interior defining housing 402/404 being pivotal relative to the fixed sector 428 via a heavy duty reclining clock spring 430 which exerts a dampening upward bias to the assembly toward the upright design position and which mounts around portions at 432/434 of a bushing welded to the mounting bracket 404, within which is fixedly received an extending splined exterior 436 of the main pivot 412. In a further variant, the spline hat interfaces with a separate motor in replacement of the DD profile 413 of the main pivot 412.

The clock spring 430 includes an inner keyed or squared profile 437 which seats over the main pivot 412, along with a circumferential curled end portion 438 which is staked to the truck bed and which, by virtue of its upward bias, facilitates dampened downward rotation of the tailgate toward the open position.

Also shown is a screw 442 and receiving washer 444 located on the reverse side of the mounting bracket 404, with the screw 442 threading into the lower main pivot 412 extending from the rear into the splined interior 434 of the mounting bracket for threadably engaging into an interiorly threaded end face (not shown) of the main pivot splined portion 436 (hidden from view in FIG. 39A).

A sealing gasket 446 is provided which is configured to seat within a perimeter defining trench or recess 448 configured within the base housing 406 and, upon assembly of the cover or cap housing 418 in order to provide environmental sealing of the interior package components of the latch assembly 400. Mounting bushings 450, 452 and 454 are provided which extend within the package interior housing at spaced apart locations and between aligning mounting apertures defined in each of the base 406 and cap 408 housings. The aligning pairs of apertures are substantially hidden in FIG. 39B, in regards to the main or base housing 406, but are shown by corresponding apertures 456, 458 and 460 of the cover/cap housing 408.

A corresponding plurality of button head screws 462, 464 and 466 are provided and insert through further aligning apertures 468, 470, 472 in the supporting outer plate 402 and extend through the bushings 450/452/454 and aligning apertures, the heads of the button head screws terminating past additional aligning apertures 474/476/478 defined in the inner sandwiching plate 410, and to which are threadably engaged outer steel weld nuts 480/482/484. Without limitation, the screws 462/464/466 (along with corresponding screws 622 & 624 associated with the upper latch 600) can also alternatively be used to mount the latch to the vehicle tailgate. Also depicted are cinch fasteners 484/486/488/490 which engage with aligning pairs of outer perimeter spaced tabs configured within each of the base housing 406 and mating cap housing 408, and which are best shown by tabs 492/494/496/498 in the base housing 406 and aligning tabs 500/502/504/506 in the cap housing 408 in FIG. 39A which correspond to as further shown in each of FIG. 40 et seq.

A release lever 508 is provided on an exterior of the inner plate 410 which is supported upon an extending stem portion of a pivot release rivet 510 located within the package defined interior and extending through further aligning apertures in the cap housing 408 (at 512) and inner plate (at 514). Additional features supported upon the stem portion of the release rivet 510 within the package interior include a release gear 516, a release lever torsion spring 518 (for biasing the release gear 516 in the engaged position as will be described) and a driving gear O-ring 520. Without limitation, variants of the present invention envision the cable actuated release lever 508 being substituted by the release gear 516 alone, such as which can further contemplate a powered or electric motor driven variant for actuating release and rotation of the latch assembly.

As further shown, the stem portion of the pivot release rivet 510 includes a keyed end, at 522, which seats within a keyed inner recess 524, such as which can be conventionally defined in the base of the outer release lever 508 for slaving rotation of the gear 516 to the release lever 508. A set screw 523 with washer is provided for securing the release lever to the pivot release rivet 510. Further shown at 526 is a lost motion barrel end fitting for engaging an end of a release cable (not shown) for actuating the lever 508, pivot release rivet 510 and the release gear 516, as will be subsequently described in FIG. 40 et seq., with a conduit end fitting 527 secured to a flanged upper edge 529 of the inner plate 410 providing a guide for the release cable.

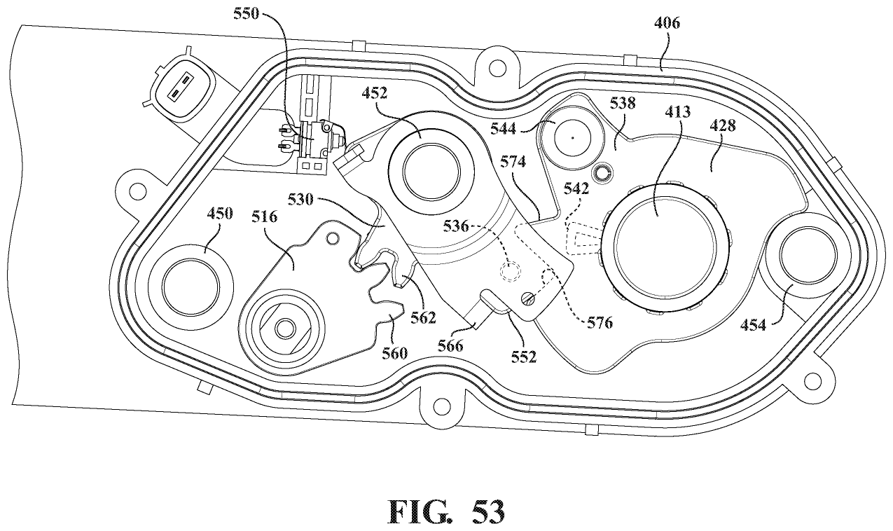

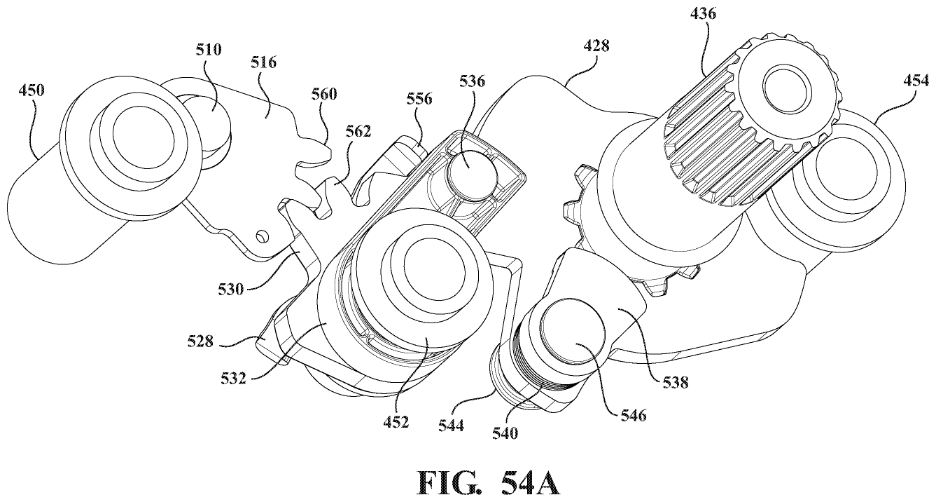

A further subset of package defining components are arranged between the release gear 516 pivotally supported to the release pivot rivet 510 and the main pivot supporting (truck bed affixed) sector 428 for facilitating selective rotation at different progressions between each of a fully upright design/latched position (FIG. 40) and a fully downward rotated position (FIG. 53). These will be better explained with reference to FIG. 40 et seq. and include each of a cinch cam 528, pawl 530, and cam follower 532 which are assembled in a stacked relationship pivotally or rotatably supported upon the middle through bushing 452 within the package defined interior of the lower latch, and so that the cinch cam 528 and cam follower 532 are on opposite sides of the pawl 530.

A torsion cinch spring 534 influences the cinch cam 528 in the design position. A rivet 536 secures the cam follower 532 to the pawl 530. A pawl blocker 538 with a torsion pawl blocker spring 540 biases against the influencing motion of an inner protuberance (see at 542 in FIG. 40) which is formed on an opposing inner facing surface of the inner/base housing 406 (further hidden from view in FIG. 39B). A slotted spring pin 541 mounts to a further inward aperture 543 of the sector for engaging a selected end of the torsion pawl blocker spring. Other features include a cinch bushing 544 and cinch rivet 546 offset from said main pivot 412 for mounting the pawl blocker 546 to an outer edge proximate aperture location (548) of the sector 428.

Also shown is microswitch 550 mounted within the package interior of the lower latch. The microswitch in a pickup truck's tailgate latch assembly acts as a precise electronic sensor, with its primary purpose being to detect the physical position of the pawl 530, signaling to the vehicle's computer whether the pawl 530 is locked/unlocked (i.e. open or closed).

Proceeding to FIG. 40, presented is a first of a number of plan progression illustrations of the lower latch assembly of FIG. 37, with the housing cap 408 removed along with a number of other extraneous components previously identified in FIGS. 39A-39B for purposes of ease of illustrations. FIG. 40 corresponds to the lower latch 400 depicted in an upright or design position and initially depicting the arrangement of the gear 516, pawl 530, cinching cam 528 and sector 428.

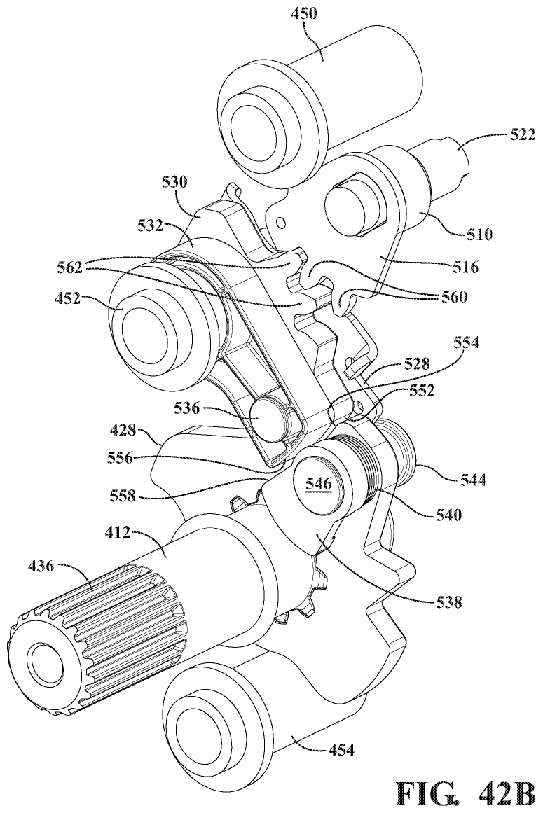

In the initial design position, the cinch cam 528 contacts cinch bushing 544 mounted to the fixed sector 428, with the pawl 530 in this position exhibiting an end face 552 which contacts an opposing ledge surface 554 of the sector (see as best shown in FIG. 42B) in order to prevent rotation of the latch assembly relative to the fixed sector 428 (the sector again without limitation being fixed to the side of the rear truck bed opposing the tailgate). The cam follower 532 is further shown in FIGS. 40-42B and, as best depicted in FIG. 42B, exhibits an end surface 556 which opposes a first side profile 558 of the pawl blocker 538 (prior to biased rotation of the pawl block resulting from influencing contact by the inner protuberance 542 defined on the inner surface of the base housing 448).

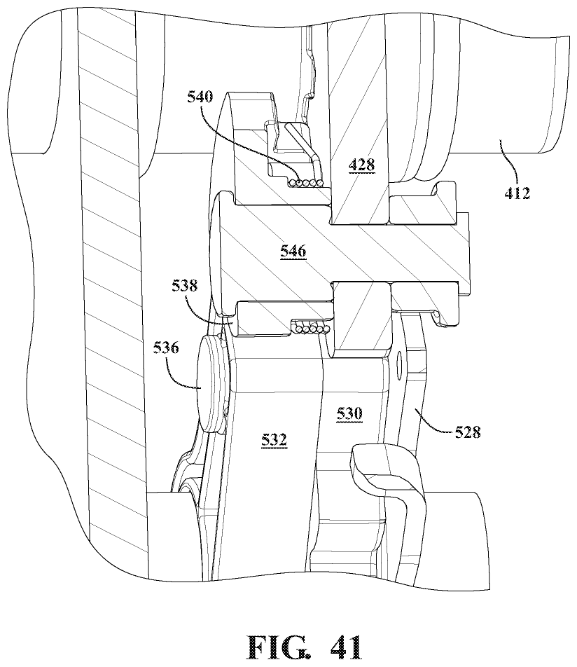

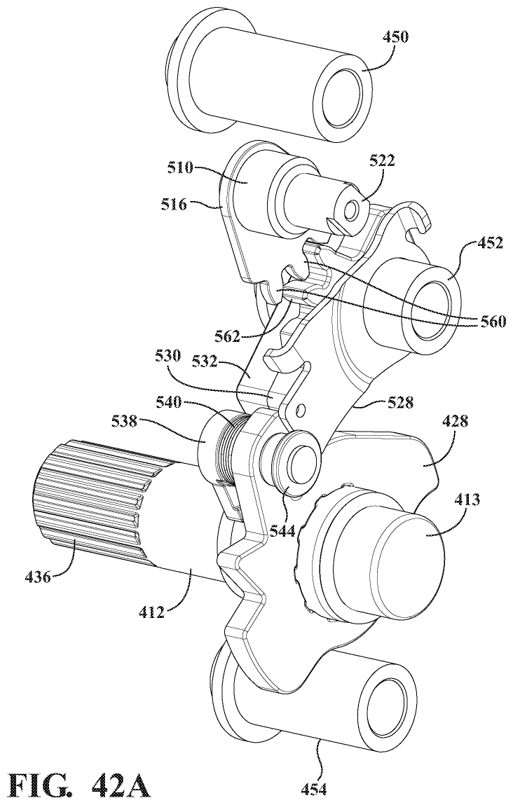

FIG. 41 is a sectional cutaway along line 41 -41 of FIG. 40 and depicting the cinch rivet 546 and bushing 544 for rotatably supporting the pawl blocker 538 against the inside surface of the sector 428 as shown, this so that rotation of the pawl blocker 538 is again influenced by the protuberance 542 located on the rear housing 406 during subsequent rotation of the latch assembly relative to the sector 428, along with again showing the pawl 530 and cinch cam 528 from another direction.

FIGS. 42A and 42B again present first and second rotated sectional perspectives of the package defining components of the lower latch assembly shown in FIG. 40, with FIG. 42B better illustrating the cam follower 532 pinned underneath the pawl 530 for interacting with the pawl blocker 538 as directed by the rotation of the inner protuberance 542.

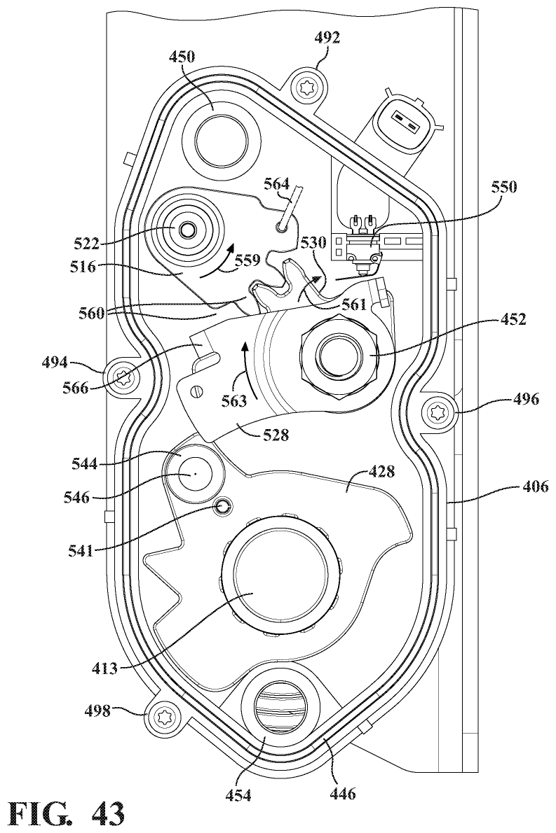

As will be described in succeeding views, actuation of the cable operated release lever 508 (again FIG. 39A) about the release pivot rivet 510 (beginning with first unlock position in FIG. 43) causes it to rotate counterclockwise (see directional arrow 559). Meshing pluralities of teeth further include as shown at 560 for the release gear 516, as well as at 562 for the pawl, resulting clockwise rotation (arrow 561) of the pawl 530, with succeeding engaged rotation of the outer cinching cam 528 about clockwise directional arrow 563.

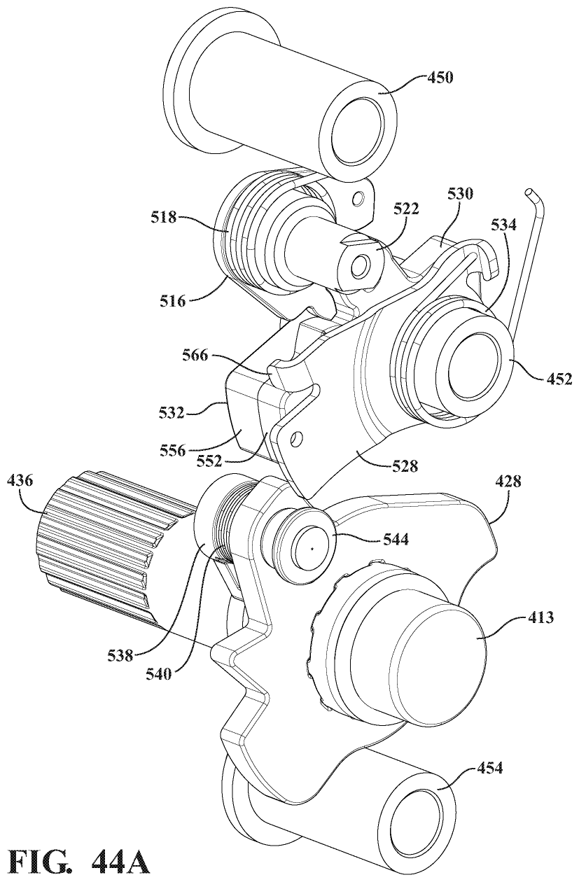

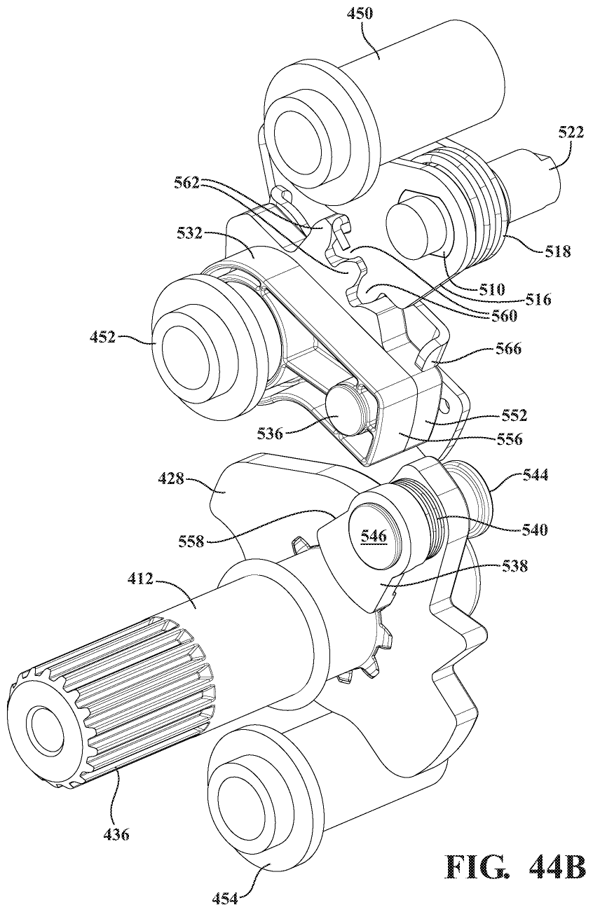

FIG. 43 is a succeeding view to FIG. 40 and depicting an initial unlock position in which the cable actuated lever 508 in FIG. 39A (see cable representatively shown at 564) is partially rotated in order to initiate counterclockwise rotation (again about direction arrow 559) of the release gear 516, with opposing clockwise rotation (again 561) of the pawl 530 until contacting a downward flange portion 566 of the cinch cam 528, the pawl 530 clearing the swing arc of the sector and prior to the cinch cam 528 being influenced by the pawl 530 to clear the swing arc sector defined with the cinch bushing 544 for permitting rotation of the latch assembly relative to the fixed sector 428. FIGS. 44A and 44B present first and second rotated perspectives of the package defining components corresponding to FIG. 43, as previously numbered in FIGS. 42A-42B,

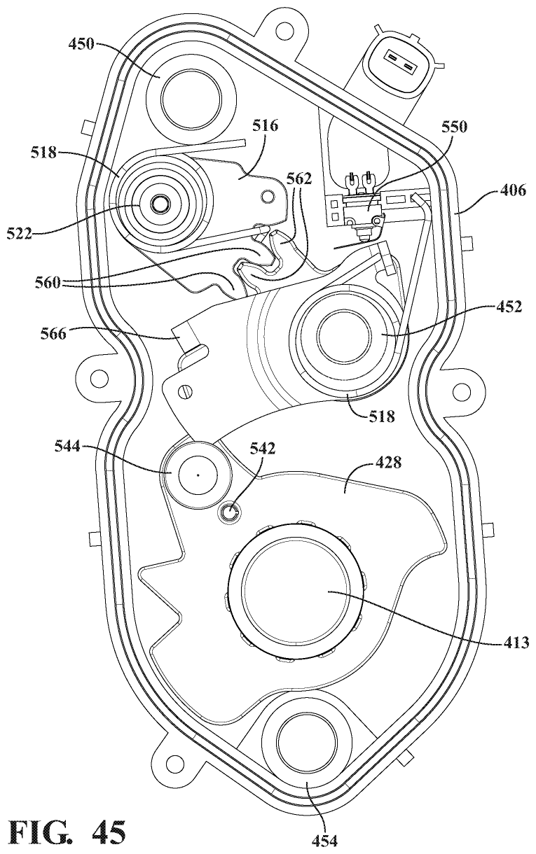

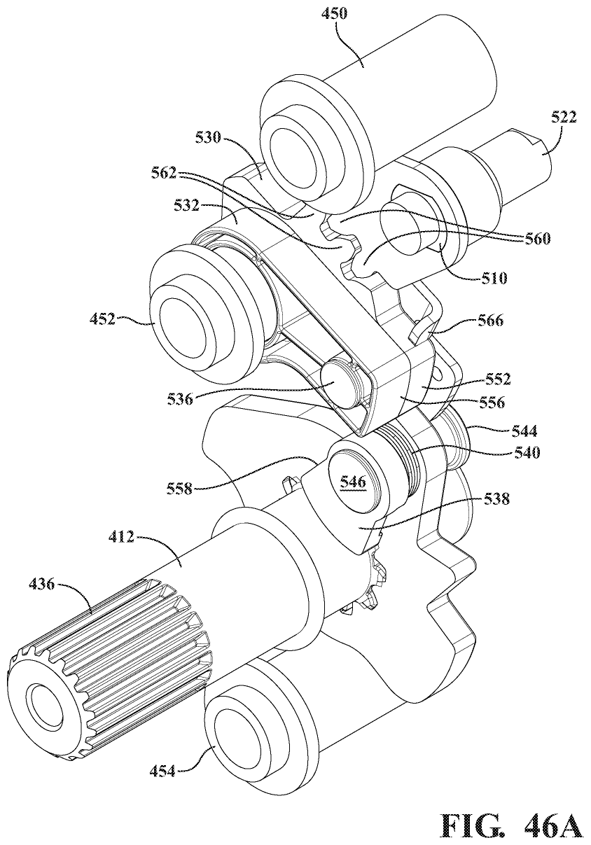

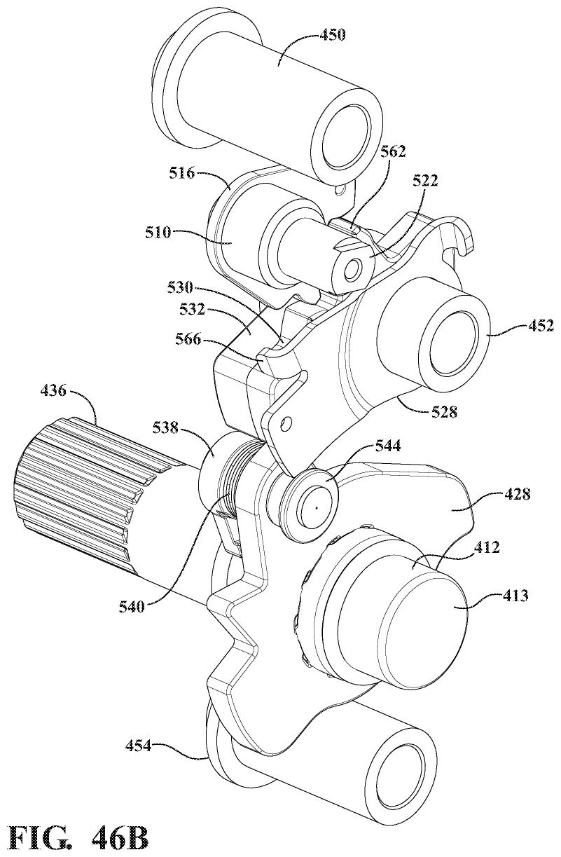

FIG. 45 presents a succeeding progression to FIG. 43, again depicting the pawl 530 and pawl blocker 538 in partial phantom, and in which an initial contact is made by the inner protrusion 542 of the main lower housing 448 as it is rotated into contact with the rotatably supported pawl blocker 538. FIGS. 46A and 46B further present first and second rotated perspectives of the package defining components corresponding to FIG. 45.

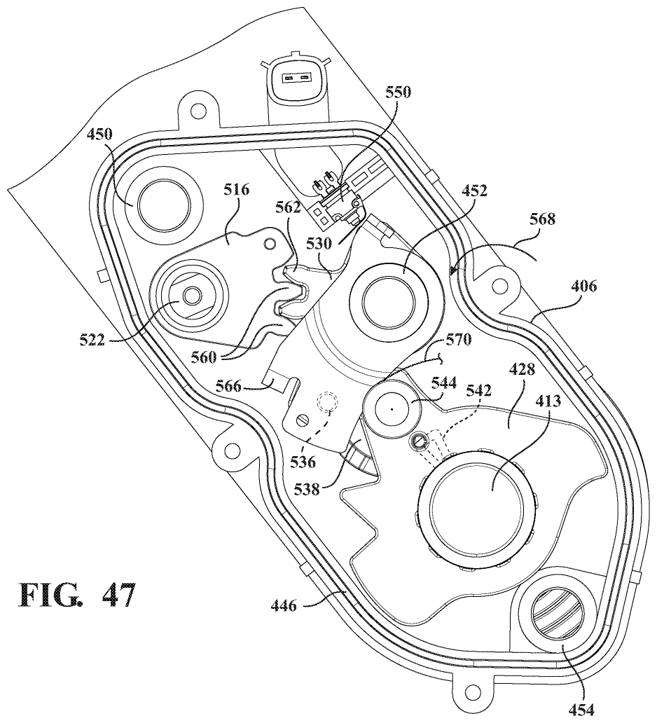

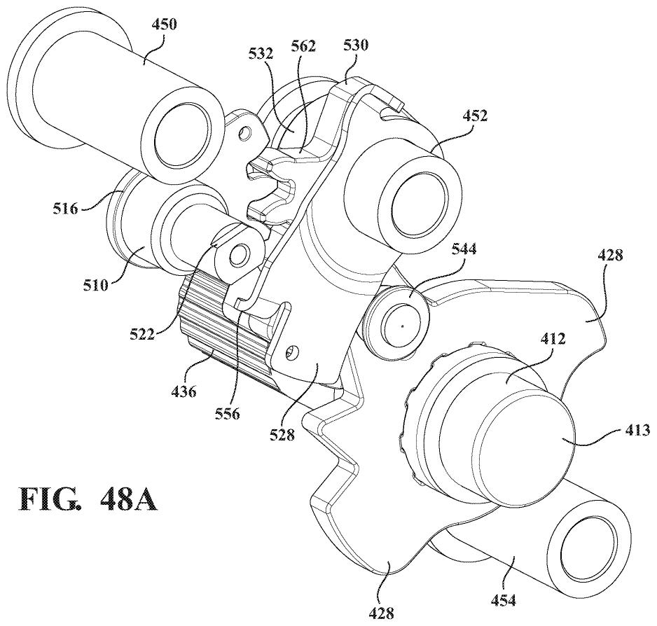

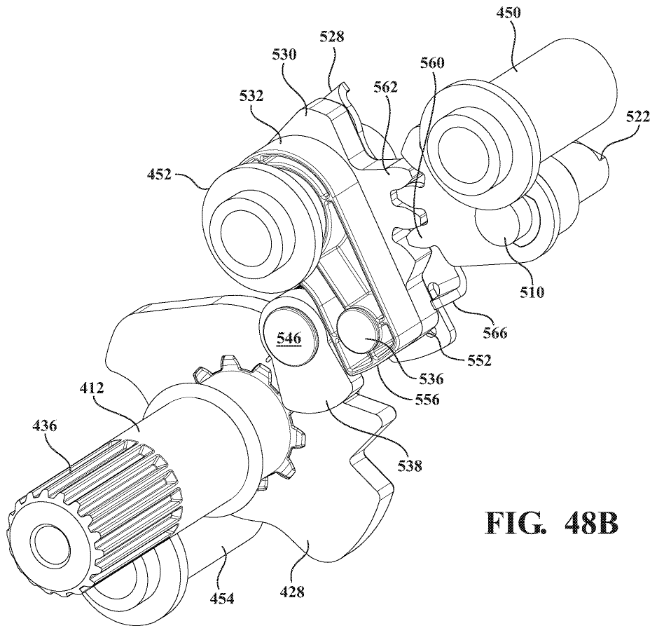

Proceeding to FIG. 47, a progression of FIG. 45 depicts an overall counterclockwise rotation of the latch assembly (as defined by the main housing 406) about the main pivot 412 (see arrow 568), with the inner protuberance 542 further rotating against the pawl blocker 538, in turn forcing it into contact with the cam follower 532 for rotating clockwise away from the cinch bushing 544, thereby clearing the swing arc sector (see line 570 in FIG. 47) in order to permit downward rotation of the tailgate 2. FIGS. 48A and 48B present first and second rotated perspectives of the package defining components corresponding to FIG. 47.

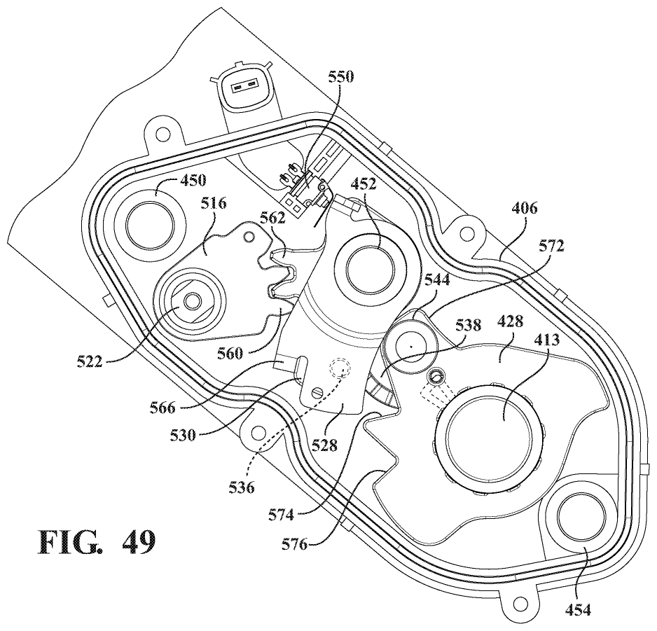

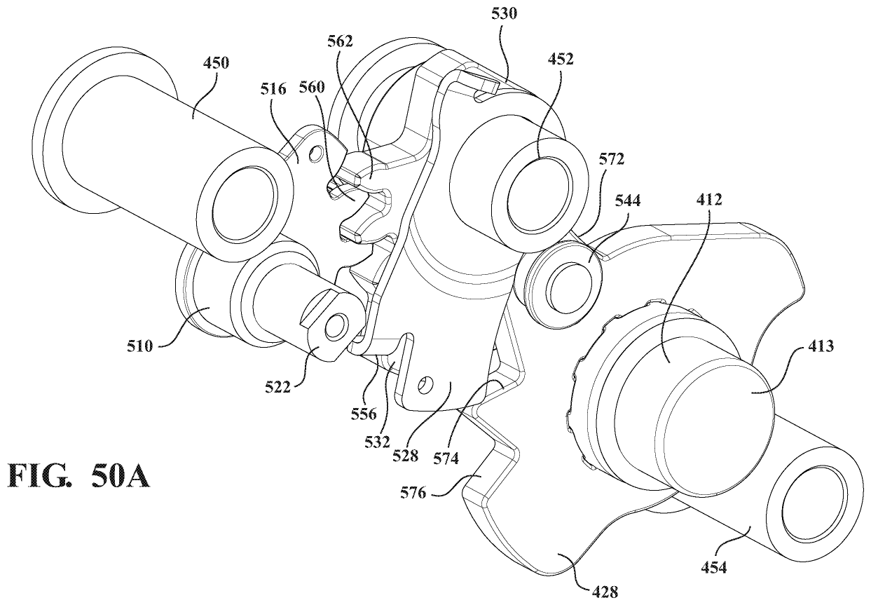

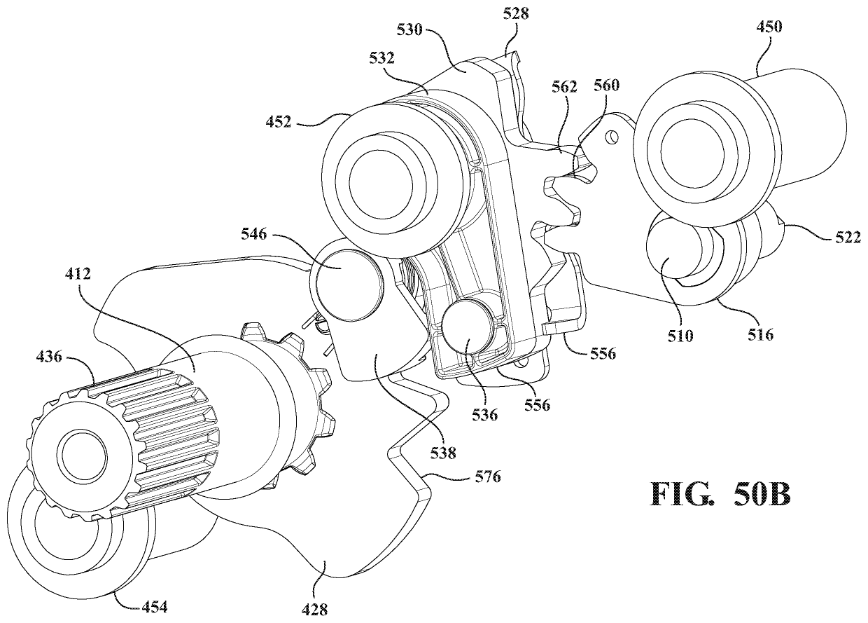

FIG. 49 presents a progression of FIG. 47 and depicting a sliding interface established between the pawl supported cam follower 532 and pawl blocker 538 during ongoing downward rotation of the tailgate 2. Also best shown in FIG. 49 are the tooth support surface locations configured in circumferentially offset locations along the sector 428 and corresponding to each of the upright design position (or “up’ position at 572) , an intermediate rotated position (or “intermediate” position at 574) and a fully downward rotated position (or “down” position at 576). FIGS. 50A and 50B present corresponding first and second rotated perspectives of the package defining components corresponding to FIG. 49 taken from different vantage points and with additional features removed for clarity of representation.

While the present invention depicts a three-position adjustable latch, it is also envisioned and understood that the sector 428 can be redesigned in order to provide any number of intermediate engagement positions between the up and fully rotated down positions. Additional variants can further include rotation only between upright and downward rotated positions, with the up and down positions also not limited to any set angular offset therebetween such as ninety degrees.

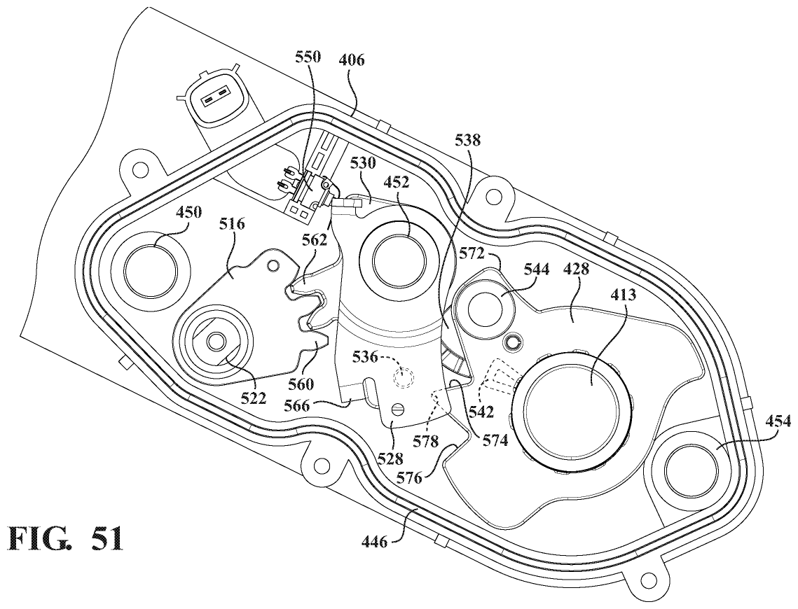

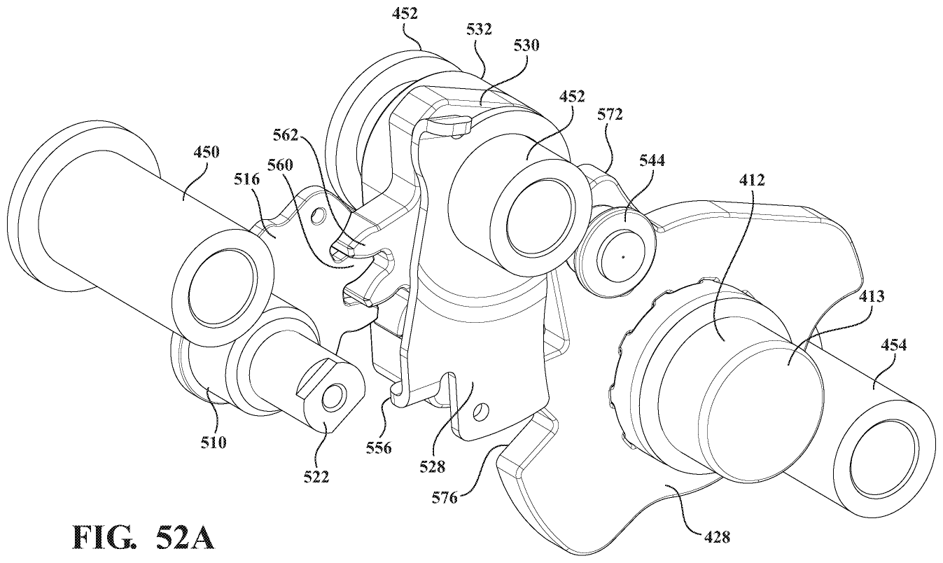

FIG. 51 is a further progression of FIG. 49 and depicting the rotatably supported pawl blocker 538 at a maximum rotation angle relative to the pawl 530 and cam follower 532, corresponding to downward rotation of the tailgate 2 passing the intermediate angular support position (also termed middle or intermediate sector support or tooth again at 574) defined by the sector 428, and at which point contact is handed off from the pawl blocker 538 to the pawl middle tooth support (defined by end shoulder 578 of the middle support 574).

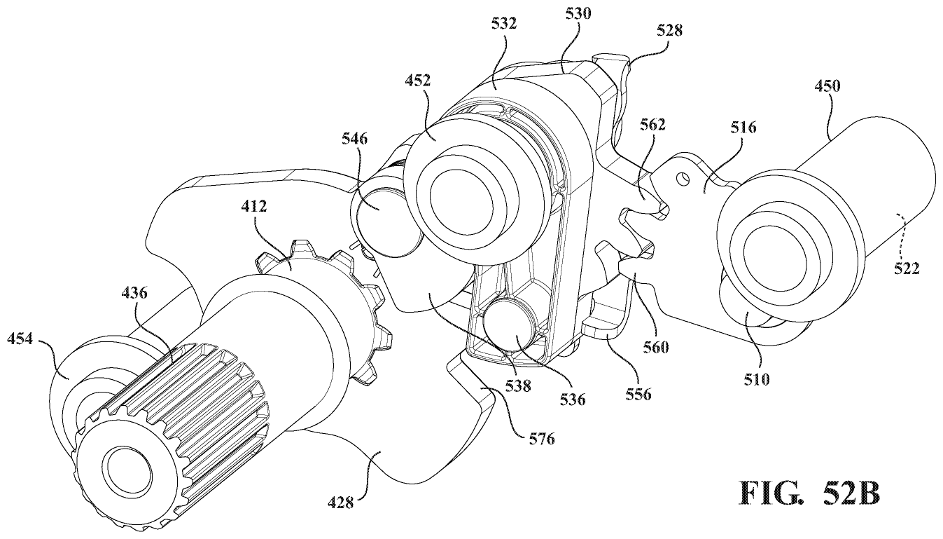

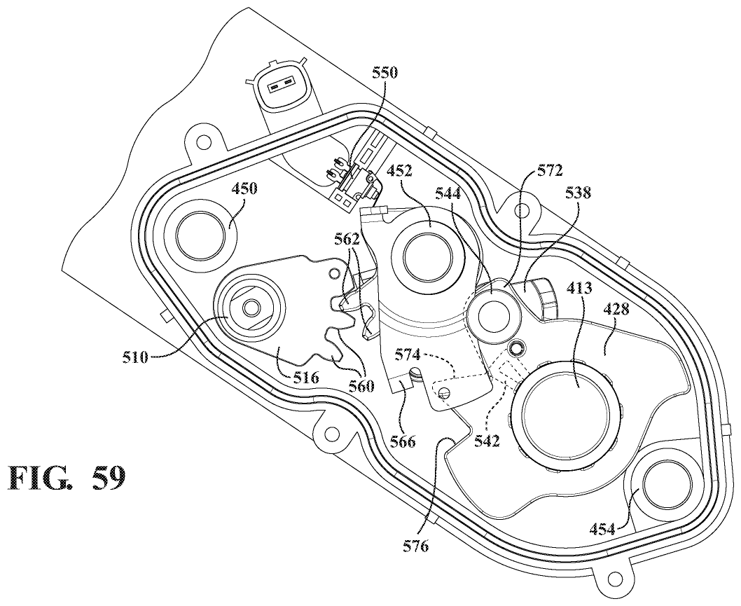

At this point the tailgate 2 can be slightly reverse rotated in an upward direction in order that the pawl 530 (via end surface 552 identified in FIG. 42B) seats upon the middle sector support tooth surface 574 in order to lock the tailgate in the middle position. Alternatively, the lower latch can continue on with its progressions as described, and in order to fully rotate the tailgate downwardly to its fully open horizontal position, with subsequent return upward rotation from the fully down position again resulting in the pawl 530 seating the middle tooth support 574 to establish the intermediate latch position as shown in FIG. 59. FIGS. 52A and 52B further present first and second rotated perspectives of the package defining components corresponding to FIG. 51.

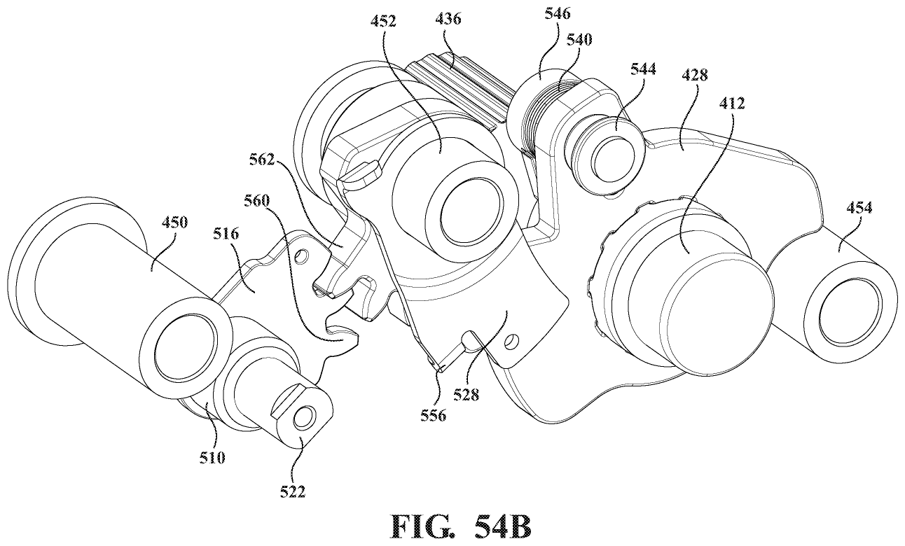

FIG. 53 is a further progression to FIG. 51 representing the tailgate latch in a fully downward rotated position and by which the inner housing protrusion 542 has rotated past the pawl blocker 538, permitting the pawl blocker 538 to return counterclockwise rotate to its initial spring influenced position (and thereby permitting the tailgate 2 to be reverse upwardly rotated to each of the intermediate and fully upright/design positions). FIGS. 54A and 54B present first and second rotated perspectives of the package defining components corresponding to FIG. 53, again provided according to a simplified arrangement.

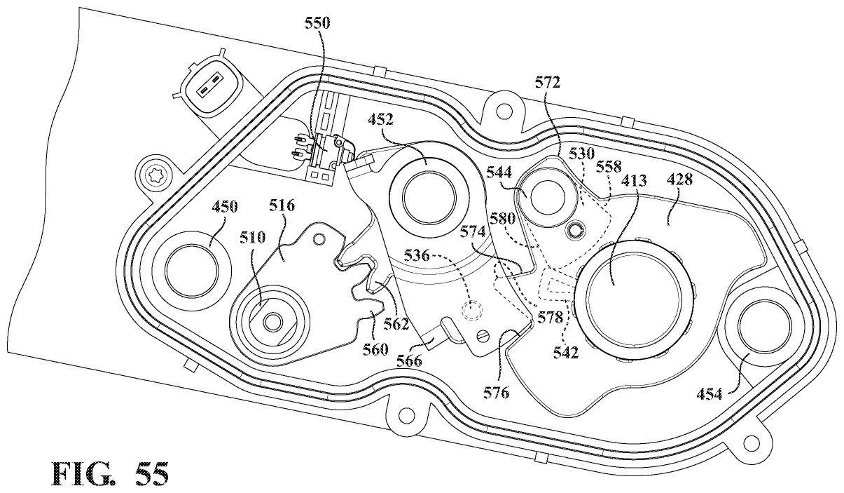

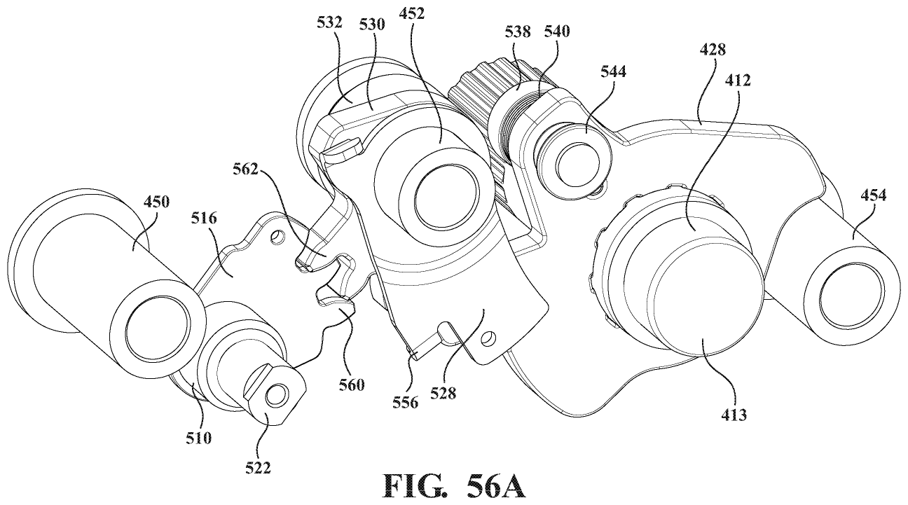

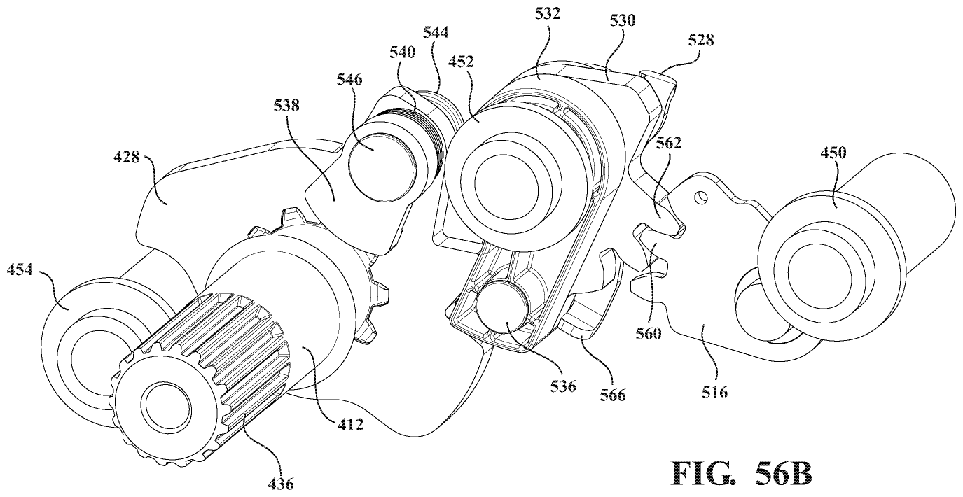

FIG. 55 presents a further progression to FIG. 53 and showing an initial upward reverse/return motion of the tailgate 2 in a clockwise direction and corresponding to initial contact established between the inner housing protrusion 542 and an opposite side of the pawl blocker 538 (shown at 580 along with initial contacting side 558 during the downward reclining motion). Initial upright rotation also corresponds to end shoulder 578 of the sector 428 engaging an opposing surface of the pawl 530, with the pawl in turn engaging the inwardly turned flange 566 of the cinching cam 528 to again influence the pawl and cinching cam in the clockwise direction arrows 561 and 563 previously identified in FIG. 40 in order to unseat from the downward tooth support surface 576. FIGS. 56A and 56B present first and second rotated perspectives of the package defining components corresponding to FIG. 55.

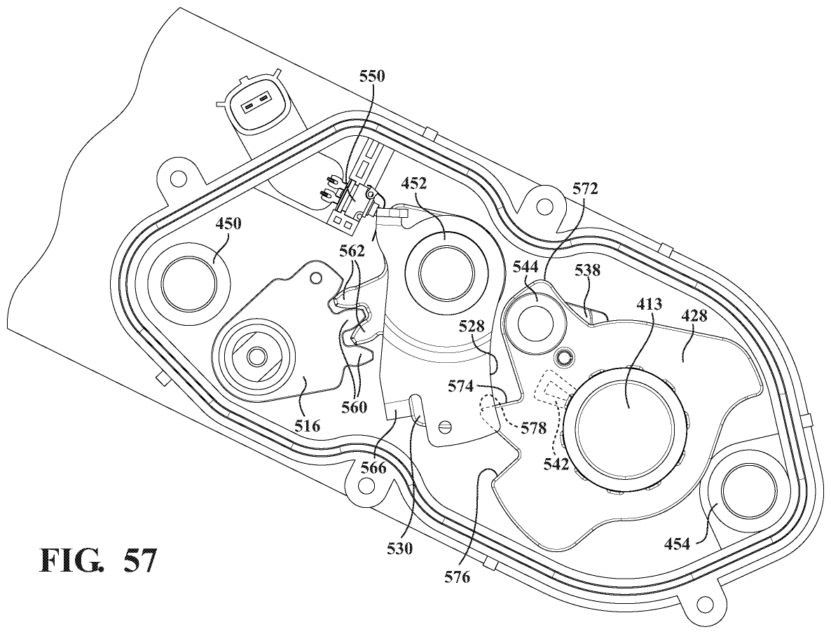

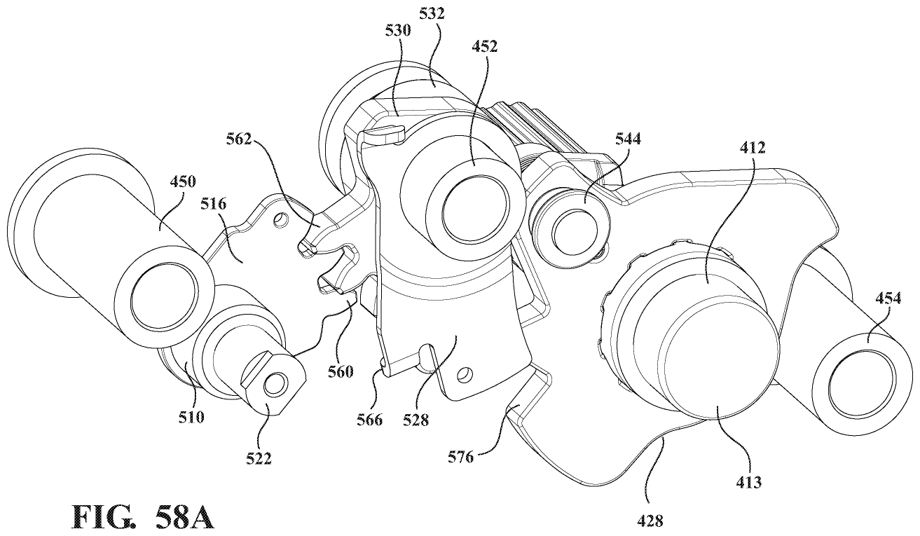

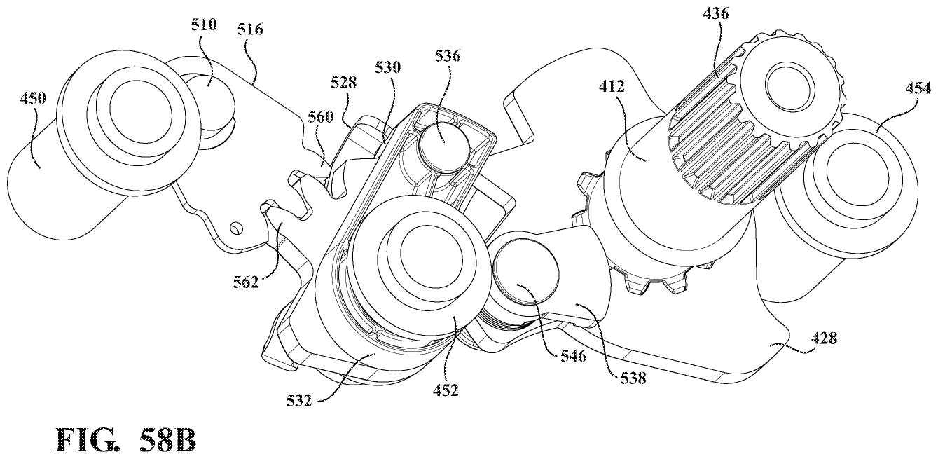

FIG. 57 presents a further upright return progression to FIG. 55 and showing continued influencing clockwise rotation of the pawl 530 and cinching cam 532 by the center tooth end shoulder 578 of the sector, corresponding to continued counterclockwise rotation of the pawl blocker 538 as influenced by the inner protuberance 542 at a position just prior to locking of the pawl 530 with the center/intermediate tailgate support position of the sector (again middle tooth 574 of the sector 428). FIGS. 58A and 58B present simplified first and second rotated perspectives of the package defining components corresponding to FIG. 57.

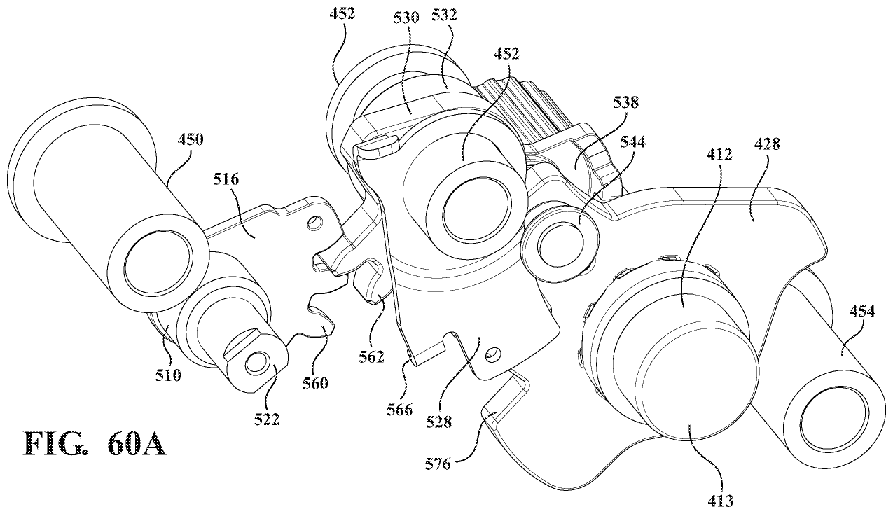

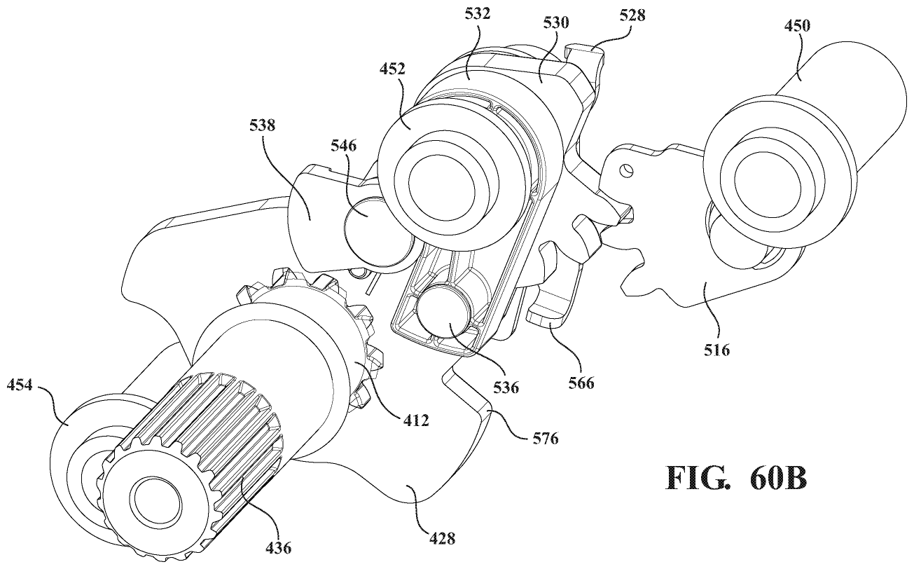

FIG. 59 is a further upright progression of FIG. 57 showing the pawl 530 engaged to the middle, center or intermediate position (tooth support 574) of the sector 429 and corresponding to the intermediate lock position of the tailgate 2. At this location, the pawl blocker 538 is shown fully rotated in the counterclockwise direction by the inner protrusion 542. FIGS. 60A and 60B present first and second rotated perspectives of the package defining components corresponding to FIG. 59.

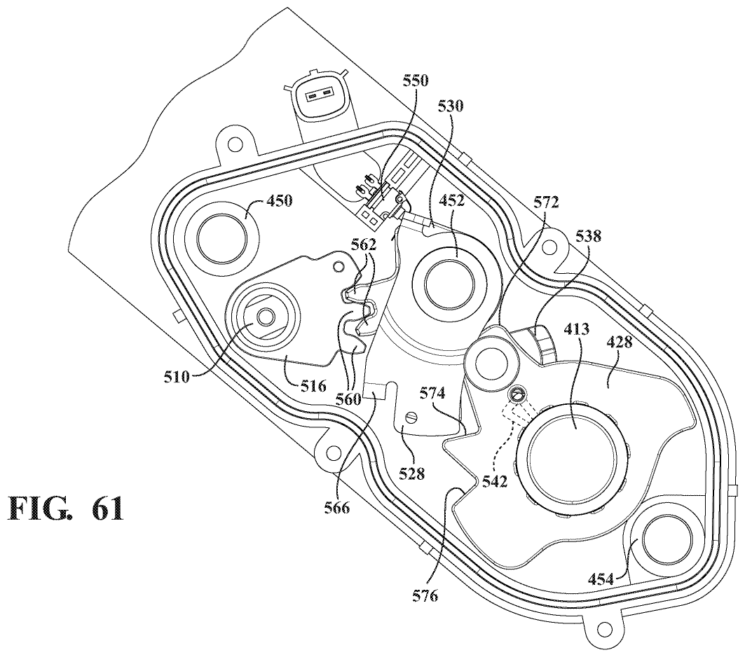

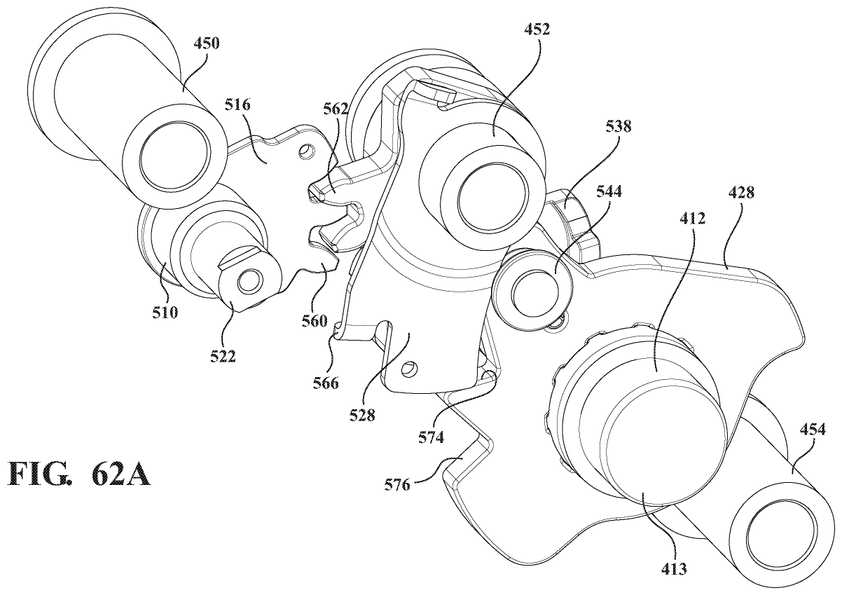

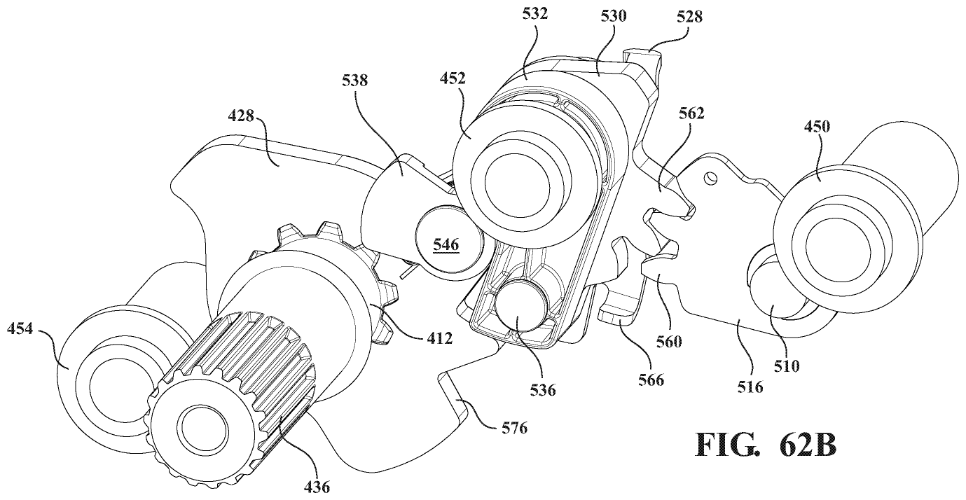

FIG. 61 presents a further upright progression of FIG. 59 in which the tailgate 2 is further rotated so that the pawl 530 is unseated from the intermediate support position of the sector (again middle support tooth 574). FIGS. 62A and 62B present first and second rotated perspectives of the package defining components corresponding to FIG. 61, again in a simplified arrangement.

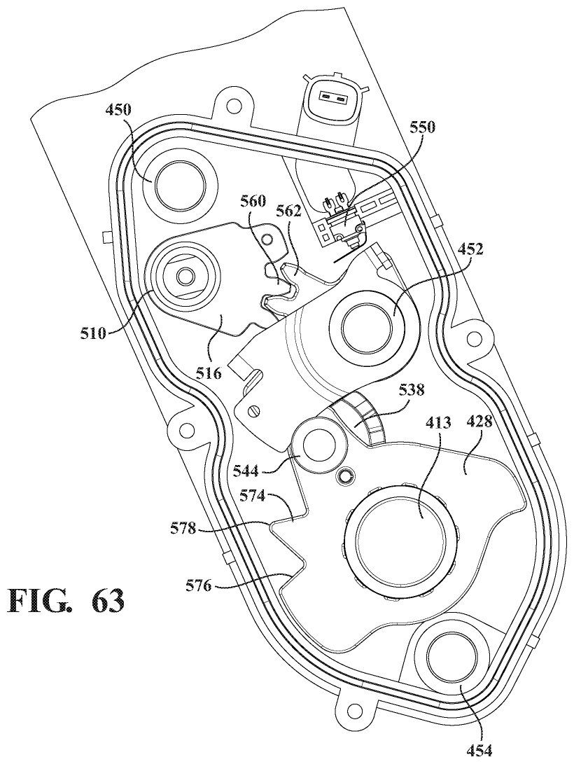

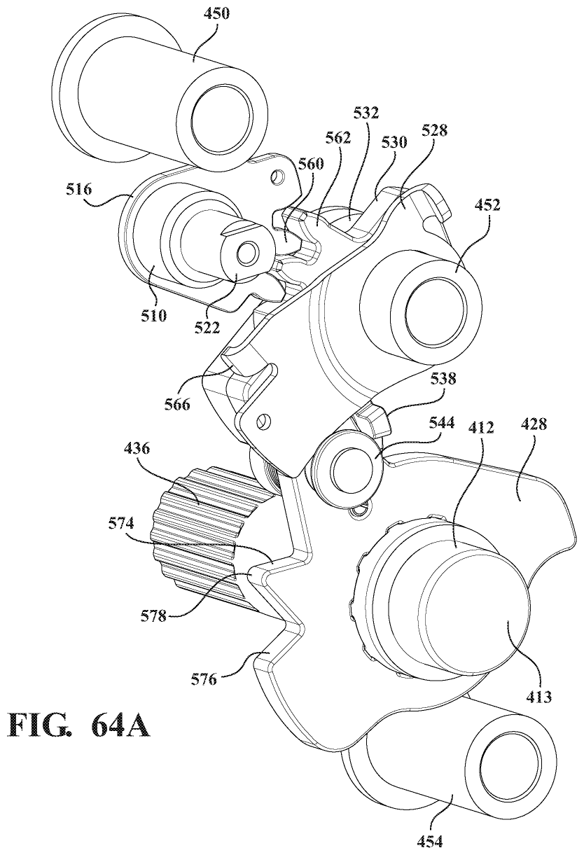

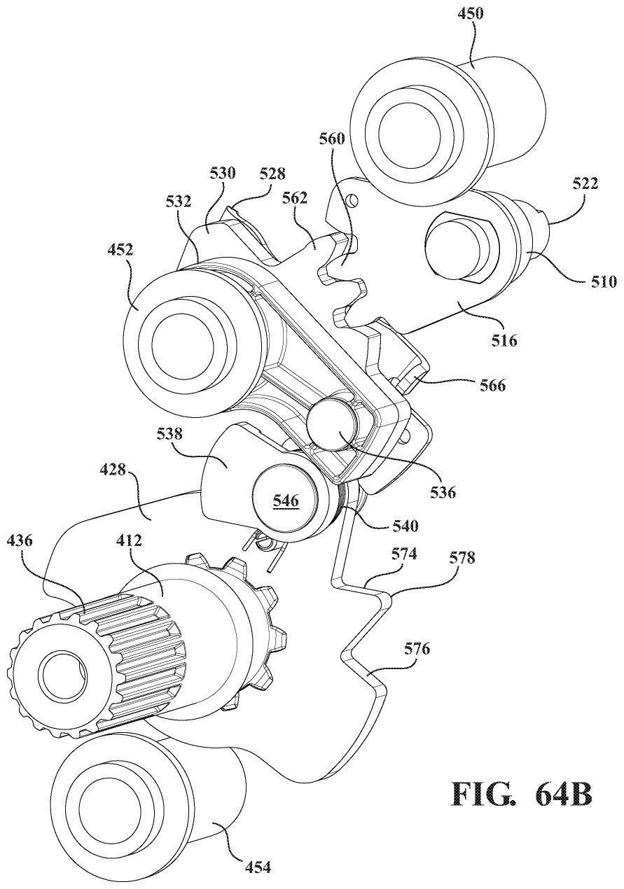

FIG. 63 presents a further succeeding progression to FIG. 61 and showing the pawl blocker 538 at its maximum counter-clockwise rotation position, as influenced by the clockwise rotating protuberance 542 during progressing upright rotation of the tailgate 2 beyond the intermediate support position (tooth surface 574 of the sector 428). FIGS. 64A and 64B present first and second rotated perspectives of the package defining components corresponding to FIG. 63.

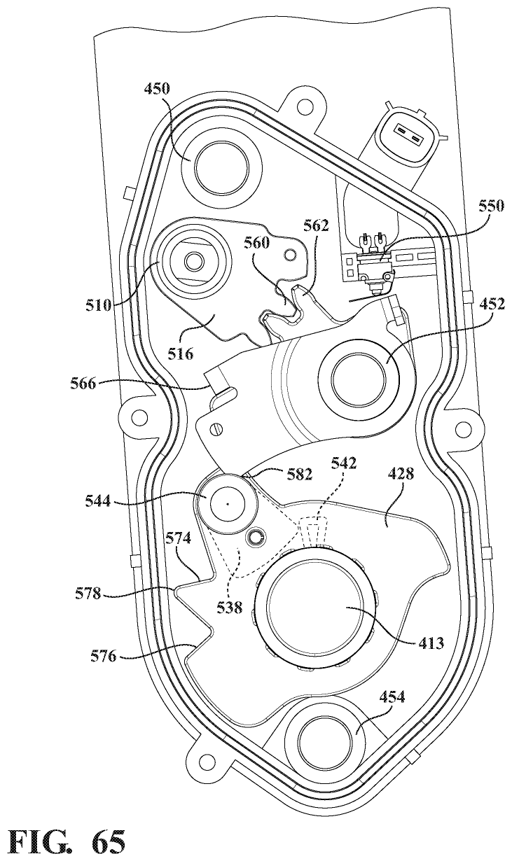

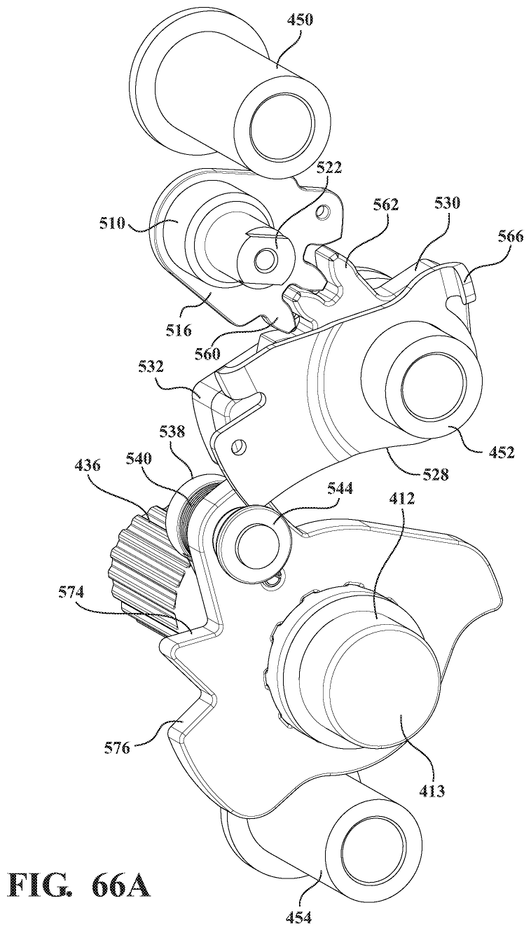

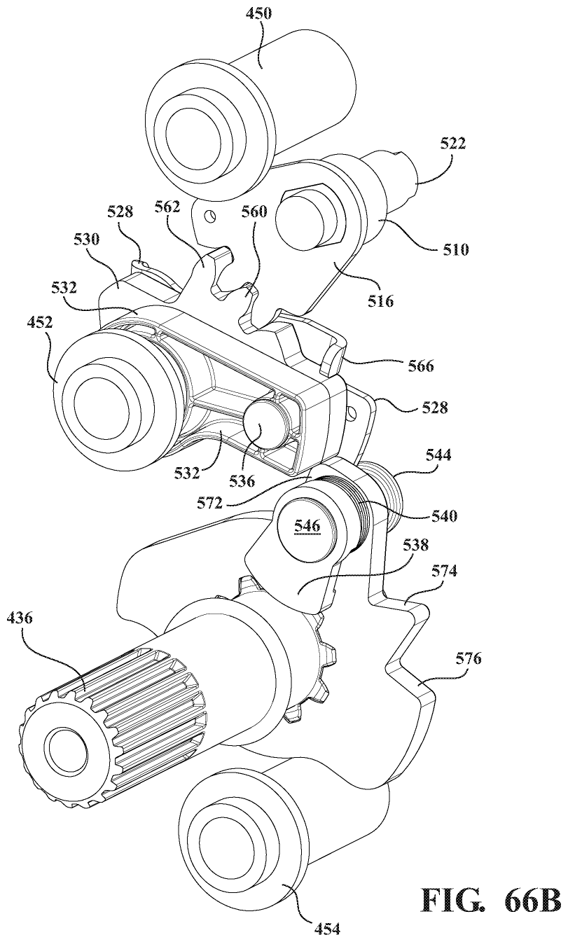

Concluding the progressions of lower latch 400, FIG. 65 is a further progression of FIG. 63, largely similar to the initial unlocked and pre-downward rotation of FIG. 43, and by which the pawl 530 is in a pre-lock configuration which remains engaged to the sector 428 (see at 582), with the pawl blocker 538 clearing the protuberance 542 so that its spring bias permits it to be clockwise rotating to a neutral position, with an incremental additional upright rotation of the tailgate 2 fully resetting the latch to the position previously depicted in FIG. 40 so that the pawl 530 resets to the upright position via engagement with the upright support tooth surface 572 of the sector 428. FIGS. 66A and 66B present first and second rotated perspectives of the package defining components corresponding to FIG. 65.

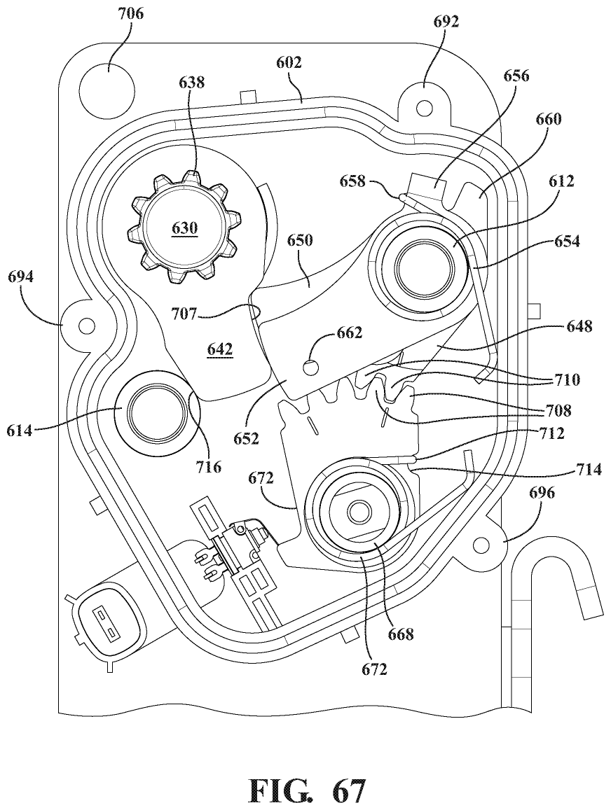

Referring back to the exploded view of FIGS. 39A-39B, and prior to a description of the progression views of FIGS. 67-75, the upper latch 600 includes a main or base upper housing 602 and an assembleable cap housing 604 for defining an upper package interior. As further shown, the base upper housing 602 includes a perimeter extending recess or trench 606 within which is supported an upper sealing gasket 608 for providing environmental sealing of the package defining interior upon assembly of the upper cap housing 604. As further previously described in reference to the lower latch assembly 400, the housings 602/604 can be provided as a durable plastic with the remaining package defining components, support plate and mounting plate being of a grade steel or the like.

As shown, the housing for the upper latch assembly 600 for controlling the upper split tailgate 4 (see again FIG. 37) is secured to an upper location of the previously identified support plate 402. An upper inner plate 610 is stacked over the upper cap housing 604, with through bushings 612 and 614 extending through aligning pairs of apertures in the main 602 and cap 604 housings, these best shown by cap housing apertures at 616 and 618 which align with aperture 620 and 622 in the upper inner support plate 610, such that additional button head screws 622/624 extend through the support plate 402 (via aligning apertures 623/625), assembleable upper housings 602/604 and inner plate 610 and are engaged by steel weld nuts 626/268.

An upper main pivot is shown at 630 and extends through additional aligning aperture in the base upper housing 602 (at 632), the cap housing 604 (at 634) and inner plate 610 (at 636) and, in combination with the bushings 612/614, providing additional structural integrity to the package defining interior of the upper latch housing. The main upper pivot includes a splined exterior (at 638) which seats within a mating splined receiving aperture (at 640) of an upper sector 642. A pair of upper main pivot O-rings are shown and include at 644 for seating over the main pivot against the outer edge of the sector receiving aperture 640 to seal the cap housing 604, as well as at 645 for seating over an opposite extending end 646 of the main pivot for sealing against the base housing 602.

Rotationally supported about the selected bushing 612 are stack of components including driven gear 648, structural upper cam 650 and upper cinch cam 652. An upper cinch cam torsional spring 654 is provided for influencing the cinch cam 652 and structural upper cam 650 in an engaged upright position. As will be described in further detail, the upper cinch cam 652 includes an inwardly flanged portion 656 which is engaged by an end 658 of the cinch cam torsional spring 654 in order to establish an upright design biasing contact with a projecting location at 660 of the structural upper cam 650. Also shown is a nub projection 662 of the driven gear 648 which seats within an aligning interior recess 664 of the structural upper cam 650 for slaving the upper cam 650 to the driven gear 648.

Also shown is an upper release pivot rivet 666 having a keyed end 668 which is received by release lever (see further at 700 with keyed recess at 701 as described below). The opposite end of the pivot rivet 666 also has a keyed section which interfaces with a keyed interior support 670 defined in a driving gear 672. As will be further shown, the driving gear 672 meshes with the driven gear 648, with an upper torsional gear spring 674 with supporting O-ring 675 influencing the driving gear 672 to in turn influence the meshed driven gear 648 and both structural upper cam 650 and upper cinch cam 652 to the design position. The keyed end 668 of the upper release pivot rivet 666 as shown in FIG. 39A seats through further aligning apertures 677 and 679 in the upper cover 604 and covering plate 610 respectively.

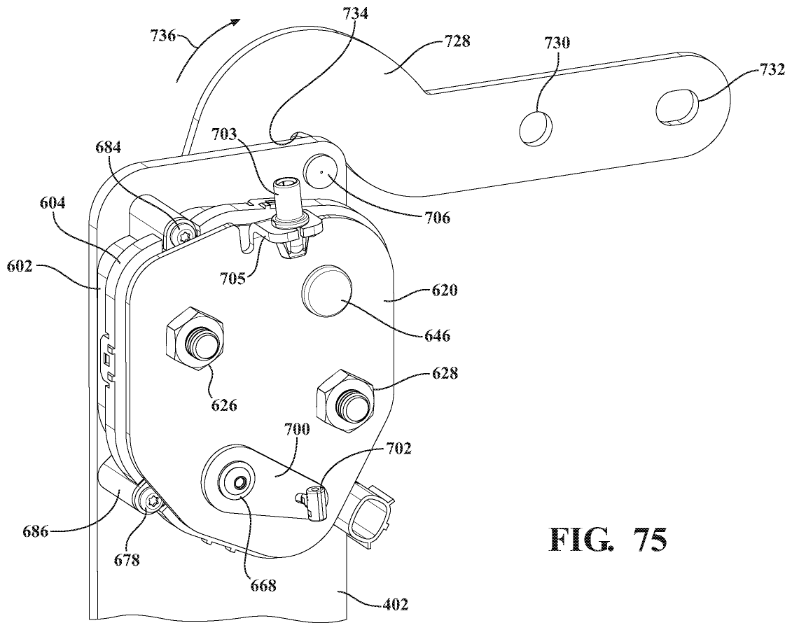

Also shown at 676, 678 and 680 are cover fastening screws provided for accessing aligning perimeter tab and seating locations defined in each of the cap housing 604 (at 684, 686, 688 and 690) and the base housing 602 (at 692, 694 and 696). The upper latch release lever 700 is provided with the keyed interior 701 which seats the keyed end 668 of the upper release pivot rivet 666. A set screw 697 with washer 699 secures the lever to the upper release pivot rivet 666 through its keyed interior. A lost motion keyed fitting 702 attaches to an end aperture location 702′ of the release lever 700 and can be accessed without limitation by a cable for pivoting the driving gear 672 via the release lever, as will be described with the following progressions of FIG. 67 et seq. An arrow head conduit end fitting 703 is further shown which is attached to an upper flanged end 705 of the upper inner plate and provides a guiding interface through which the cable (not shown) extends to the barrel end keyed fitting 702. Finally, a stop rivet is shown at 704 which is secured to an upper edge location of the support plate 402 (see aperture 706), such that the stop rivet prevents rotation of an attachment arm 728 as further shown in FIG. 75. As further shown in FIG. 39B (and as will be described subsequently in FIG. 75), a mounting bushing 738 exhibits a keyed or DD exterior profile which seats within a mating interior profile 740 defined in the attachment arm 728, with a threaded fastener 742 and support washer 744 facilitating pivotal mounting the arm 728 to an aperture 746 located at an upper region of the support plate 402 and proximate to the location of the mounted stop rivet 704.

Proceeding to FIG. 67, a first of the progression plan illustrations of the upper latch assembly 600 is again shown with the upper housing cap 604 removed and initially depicting the latch in an upright locked position, with a side edge 707 of the upper sector 642 engaged to opposing end profiles of the structural cam 650 and upper cinching cam 652. Each of driving gear 672 and driven gear 648 is shown influencing the coaxially supported upper structural cam 650 via the nub 662 extending into the seating aperture 664 of the upper structural cam 650. An upper torsional cinch spring 654 influences the upper cinch cam 652 into engagement with the upper sector 624, with releasing of the sector resulting from the structural cam 650 pulling the cinch cam 652 away from the sector 624. Also depicted are the meshing teeth established between the driving gear 672 (at 708) and driven gear 648 (at 710).

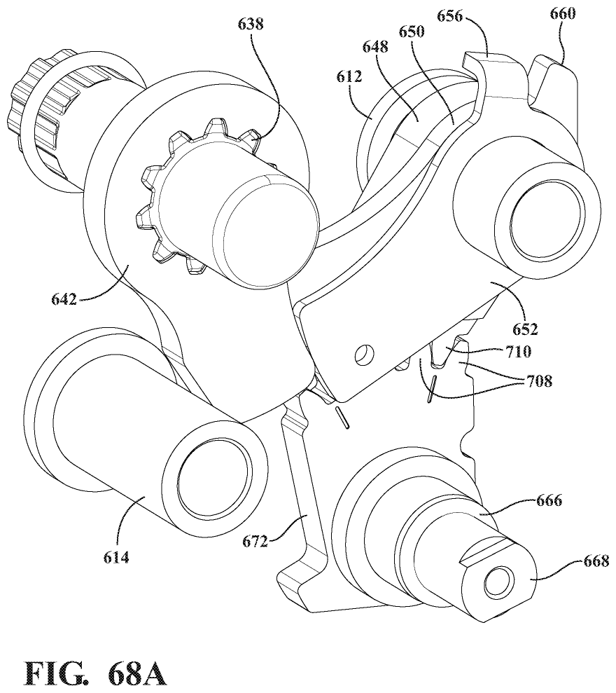

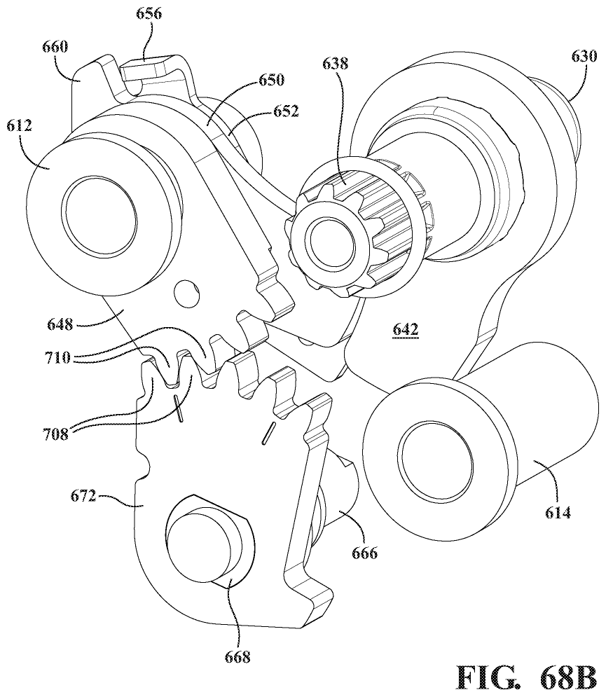

As further shown, the upper torsional gear spring 674 includes a curled end 712 seating within an edge notch 714 of the driving gear 672 for again influencing the driving gear to in turn influence the meshed driven gear 648, structural upper cam 650 and upper cinch cam 652 toward the design position. The bushing 614 in this position further operates as a stop for preventing rotation of the sector 642, and as shown by contact location 716. Referencing further FIGS. 68A and 68B, presented are first and second rotated perspectives of the package defining components corresponding to FIG. 67 in a simplified arrangement.

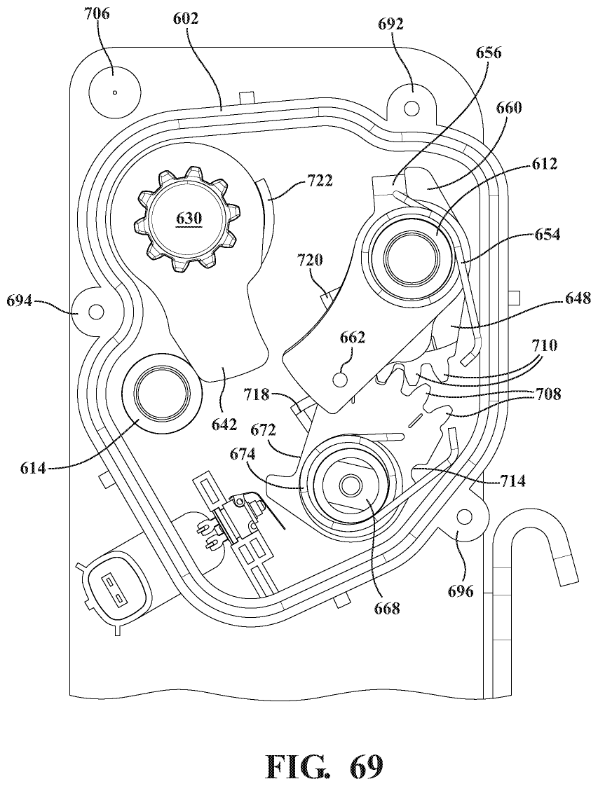

FIG. 69 is a progression view of FIG. 67 and showing actuation of the release lever causing clockwise rotation of the driving gear 672, with slaved counterclockwise rotation of the driven gear 648 and slaved structural cam 650 to contact the inwardly flanged portion 656 of the upper cinch cam 652, allowing for the sector 642 to freely rotate once the release lever 700 depicted in FIG. 37 is fully rotated by the associated release cable along with the slaved driving gear 672.

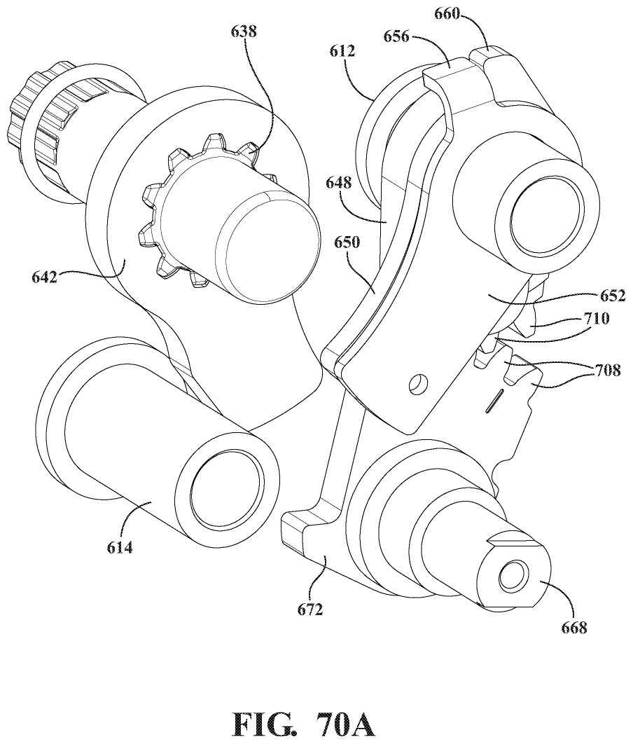

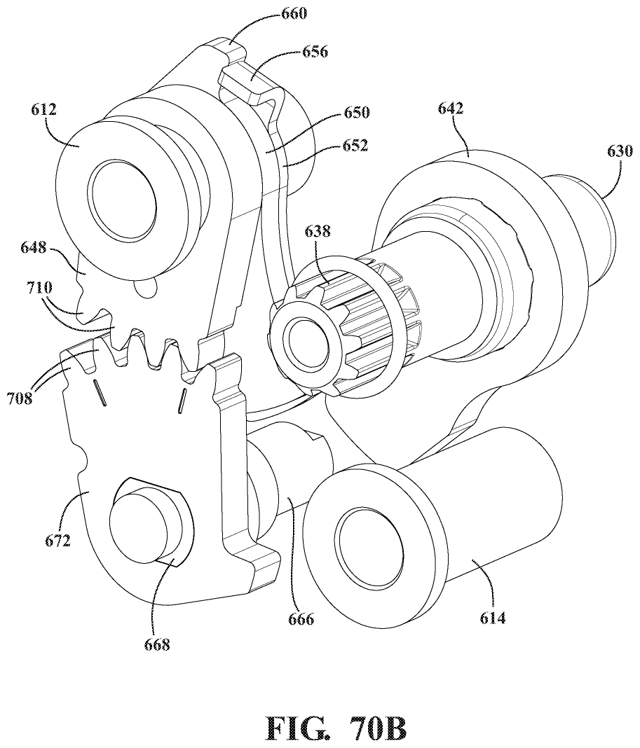

Also shown are arcuate ride ribs 718, 720 and 722 formed upon the opposing inner face of the base upper housing 602 and which assist in maintaining lateral spacing of the various components, with ride rib 718 supporting rotation of the driving gear 762, ride rib 720 supporting the driven gear 748 and ride rib supporting the sector 642. FIGS. 70A and 70B present first and second rotated perspectives of the package defining components corresponding to FIG. 69.

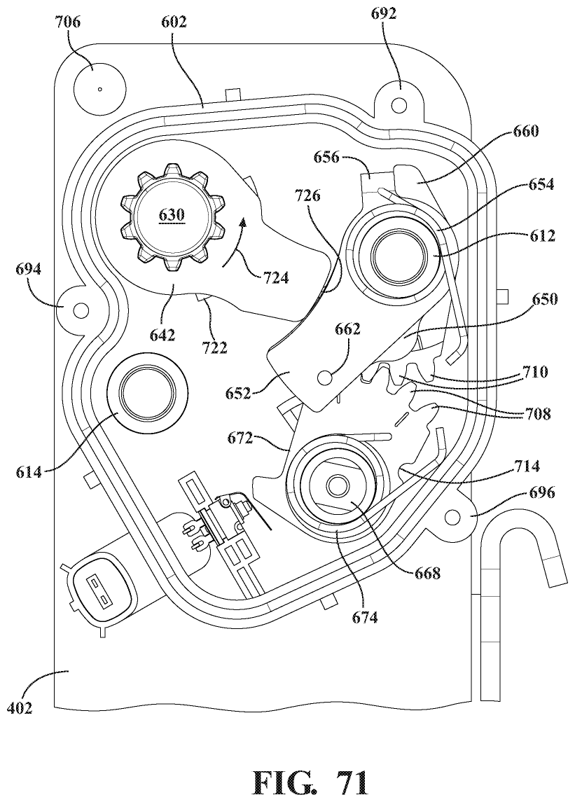

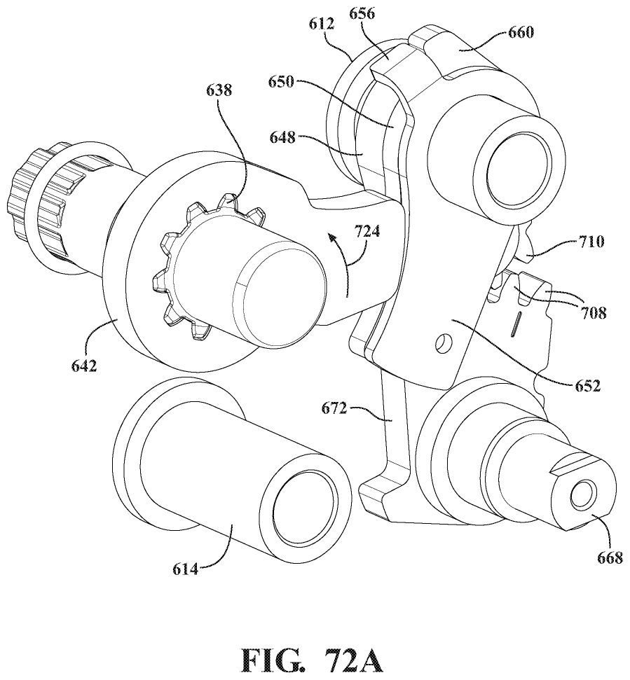

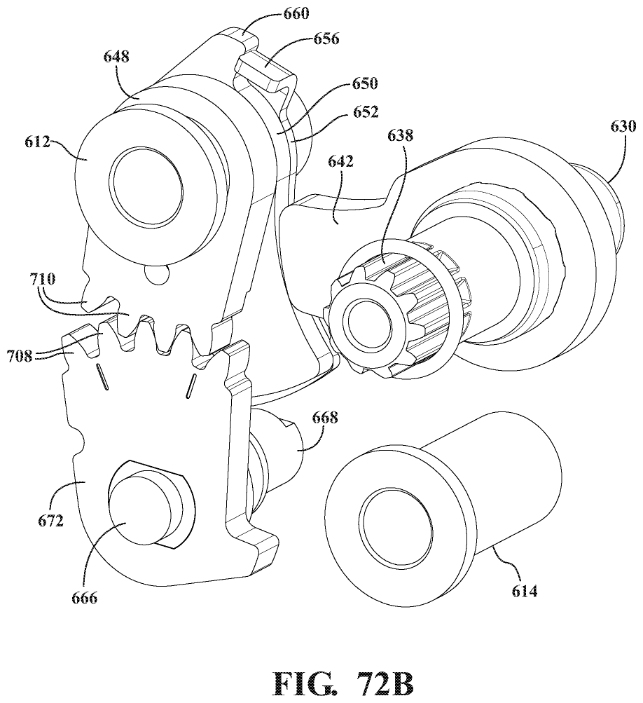

Proceeding to FIG. 71, a progression view of FIG. 69 is shown with counterclockwise rotation of the sector 642, depicted by directional arrow 724 corresponding to a one half travel condition and in which an arcuate outer edge 726 of the sector 642 so that it rotates freely of the structural cam 650 and cinch cam 652, as compared to the engaged position of FIG. 67. As further shown, the associated arcuate ride rib 722 provides lateral support to the sector 642 during rotation. FIGS. 72A and 72B present first and second rotated perspectives of the package defining components corresponding to FIG. 71.

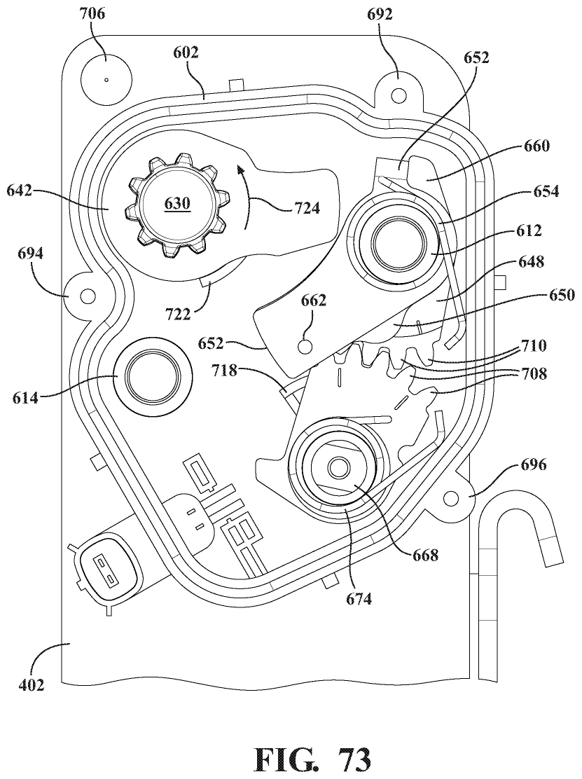

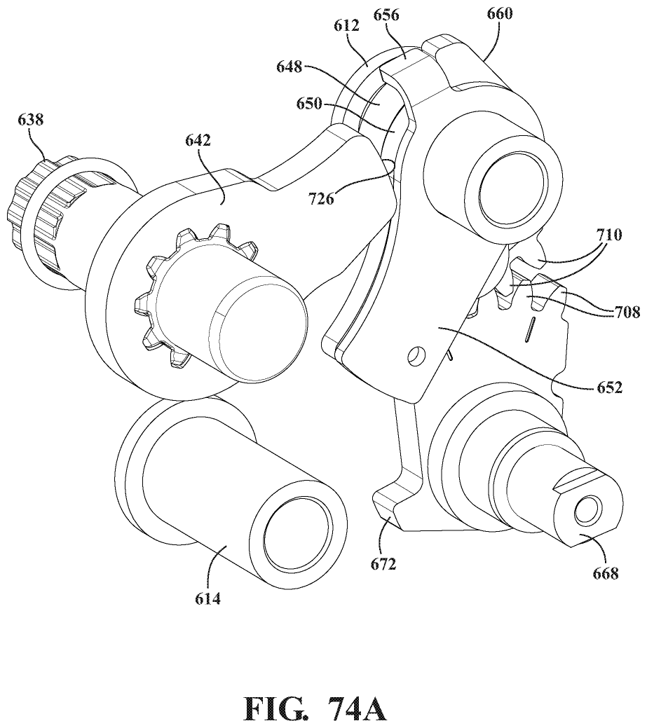

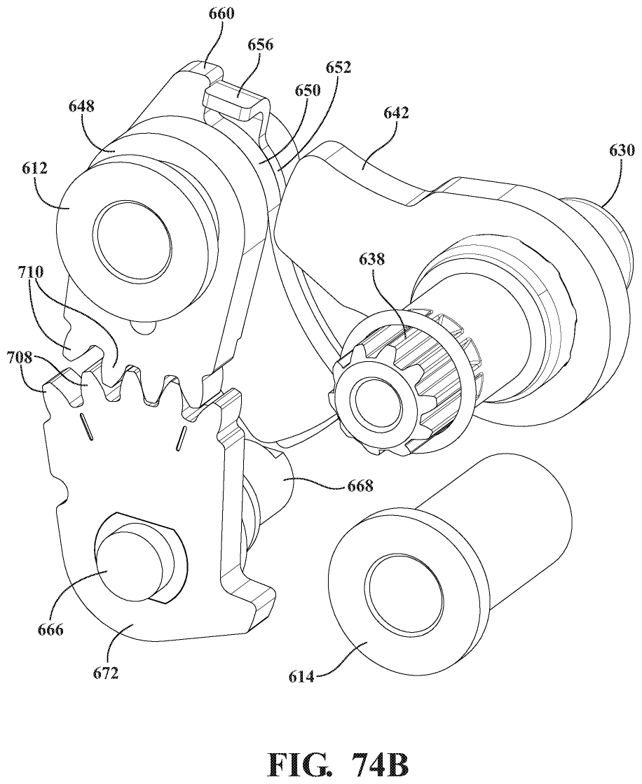

FIG. 73 is a progression of FIG. 71 and represents a fully down position of the upper latch assembly 600, with FIGS. 74A and 74B concurrently present first and second rotated perspectives of the package defining components corresponding to FIG. 73. FIG. 75 is a corresponding assembled perspective of the split tailgate supporting upper latch assembly and showing the configuration of the attachment arm 728 which is supported about the main splined pivot 638 and slaved to the rotatable sector 642.

As shown in FIG. 75, the arm 728 as previously referenced in FIG. 39B is configured having an elongated and generally “L” shaped configuration with a first end mounted over the splined portion 436 of the main pivot (largely obscured on a rear side of FIG. 75), and with an extending end of the arm 728 exhibiting mounting apertures 730/732 for receiving fasteners (not shown) for mounting the respective side of the upper split tailgate 4. Further shown at 734 is an inner facing curved edge defining a clearance for the stop rivet 706 and which, upon the arm 728 being pivoted fully in the direction represented by arrow 736 and corresponding to similar arcuate directional arrow 724 associated with pivoting of the sector 642, results an adjoining surface of the arm 728 located proximate the inner curved clearance defining edge 734 and to the right of the strop rivet 706 contacting the stop rivet 706 mounted to the upper edge of the outer support or base plate 402, in order to define the fully down position of the upper split tailgate 4.

As previously described, the present invention contemplates either of matching upper and lower latch assemblies arranged on either side of the truck bed, opposing the rear tailgate, or a single such latch assembly provided on a selected side, with a colinear main pivot arranged on an opposite side of the truck bed for engaging the opposing facing side of the inner position tailgate.

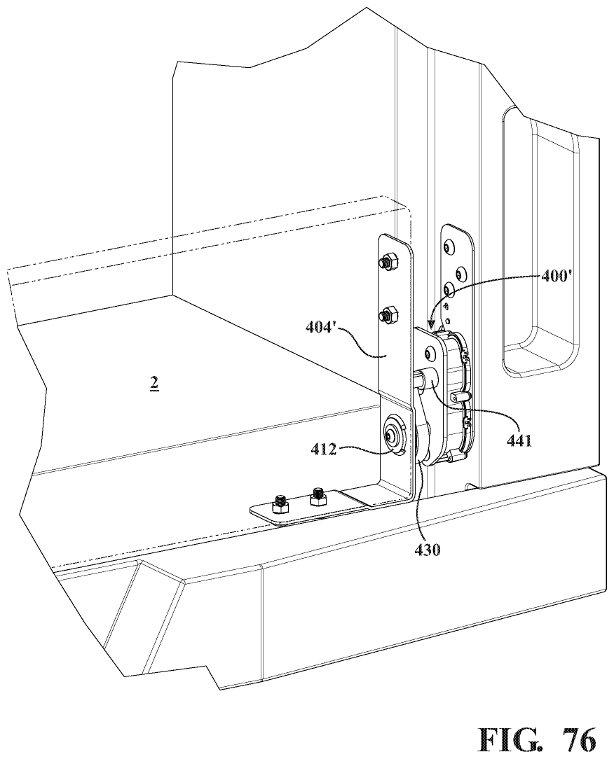

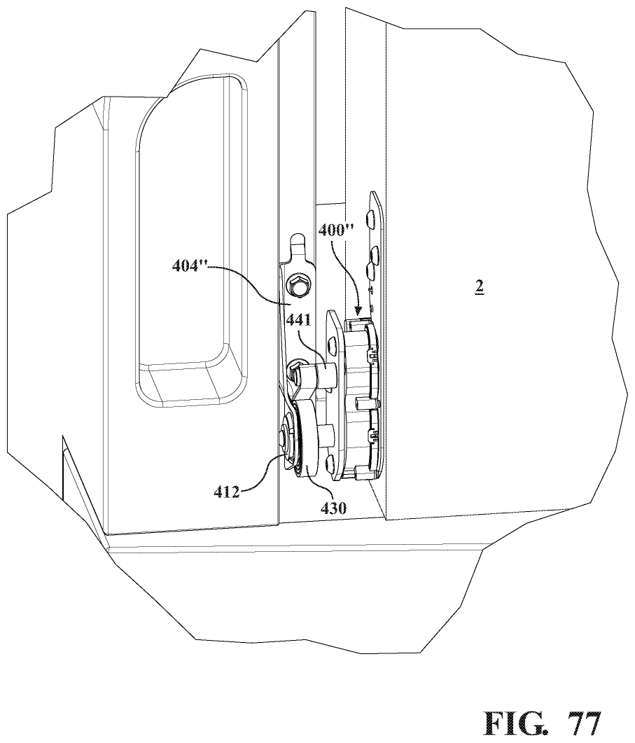

As depicted in FIGS. 76 and 77, the present invention also contemplates alternate variants for the lower latch assembly 400 and in which the latch assembly is mounted to the truck bed/frame such that the latch is fixed and the sector 426/main pivot 412 rotates with the tailgate 2. FIG. 76 presents a variant 400′ of the lower latch assembly in which the latch mechanism is stationary mounted between the truck bed and opposing the pivotal tailgate 2, and utilizing a variant of mounting bracket 404″ to the truck bed to permit dampened downward motion associated with a rotatably supported sector component (not shown). According to this variant, the core latch components are mounted to and rotatable with the tailgate 2, while the sector 426/main pivot pin 412 and the supporting bracketry are fixed to the truck bed.

FIG. 77 presents an illustration of a further variant 400″ of the lower latch assembly in which the arrangement is reversed so that the sector is stationary (not shown but consistent with that previously described) is mounted relative to the latch mechanism which pivots downwardly in dampened fashion with the tailgate 2. According to this variant, the sector, pin and bracket are mounted to and rotatable with the tailgate, with the core latch components are fixed to the truck bed. The illustrations of FIGS. 76-77 are intended to provide non-limiting arrangements for mounting the latch assembly 400 between the truck bud and pivotally associated tailgate, and again so that sector/main pivot components can be configured so as to be either fixed or rotating with the tailgate.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A latch assembly for pivotally securing a tailgate to a bed of a truck, comprising:
a housing defining a package interior containing a sector for receiving a main pivot secured to the truck bed;
a pawl selectively engageable with circumferentially offset support surfaces of said sector corresponding to at least up and down positions of the tailgate; and
a cinch cam rotatably supported on one side of said pawl for engaging, in the up position, a support bushing secured to said sector at a location offset from said main pivot; and
actuation of said pawl displacing said cinch cam in order to initiate downward rotation of the tailgate.

2. The latch assembly as described in claim 1, further comprising actuation of said pawl displacing said cinch cam from contact with said support bushing to initiate downward rotation of the tailgate.

3. The latch assembly as described in claim 1, further comprising a cam follower rotatably supported on a side of said pawl opposite said cinch cam, said cam follower selectively engaging a rotatable pawl blocker supported by a rivet which secures a cinch bushing to said sector during rotation of said housing about said main pivot, said pawl blocker preventing said pawl from engaging said sector during pivoting between the up and down positions of the tailgate.

4. The latch assembly as described in claim 1, further comprising a release gear for actuating said pawl to in turn displace said cinch cam from contact with said cinch bushing.

5. The latch assembly as described in claim 1, said circumferentially offset support surfaces of said sector further comprising an intermediate support surface between said up and down position defined support surfaces for establishing an intermediate support position between said pawl and sector.

6. The latch assembly as described in claim 1, further comprising a main clock spring supported about said main pivot for providing a dampening upward bias to said housing during downward rotation.

7. The latch assembly as described in claim 1, further comprising a lever for rotating said release gear against a bias exerted by a torsion release spring, with counter rotation of said pawl being biased by a torsion cinch spring influencing said cinch cam toward the up position.

8. The latch assembly as described in claim 1, further comprising a torsion pawl blocker spring for biasing said pawl blocker against influencing motion of a protuberance formed on an inner surface of said housing during its rotation relative to said sector.

9. The latch assembly as described in claim 1, said housing further comprising a main housing and a cap housing.

10. The latch assembly as described in claim 9, further comprising a plurality of bushings extending through said main housing and cap housing, with a middle positioned of said bushings rotatably supporting said pawl, cinch cam and cam follower.

11. The latch assembly as described in claim 1, said cinch cam further comprising an inwardly flanged portion engaged by said pawl during actuation by said release gear away from said support bushing.

12. The latch assembly as described in claim 1, further comprising meshing pluralities of teeth established between said release gear and pawl.

13. The latch assembly as described in claim 1, said sector further comprising an interiorly geared profile through which an extending splined exterior of said main pivot extends.

14. The latch assembly as described in claim 1, further comprising a support plate for securing said housing, a mounting bracket securing the support plate to the truck.

15. An upper latch assembly for operating an upper split portion of a truck tailgate separately from a lower latch assembly, comprising:
said lower latch assembly operating up and down rotation of the tailgate about a lower main pivot;
said upper latch assembly having a housing defining a package interior containing a sector rotatably supported to an upper main pivot;
an arm slaved to said sector and extending from said upper main pivot for supporting the upper split portion of the tailgate;
an upper structural cam, in combination with an upper cinching cam, being coaxially mounted with said structural cam for biasing against said pawl in a first engaged position; and
downward rotation of said arm and upper split tailgate occurring upon retracting said structural cam and cinching cam from engagement with said pawl.

16. The upper latch assembly as described in claim 15, further comprising a driving gear rotatably mounted within the package interior and biased in a first direction, a driven gear meshingly engaged with said driving gear, said upper structural cam being slaved to said driven gear which is coaxially mounted with said upper structural cam and upper cinching cam, with release rotation of said driving gear causing counter rotation of said driven gear and structural cam in order to retract said structural cam and cinching cam from engagement with said pawl to permit downward rotation of said arm and upper split tailgate.

17. The upper latch assembly as described in claim 16, further comprising a lever for rotating said driving gear against a bias exerted by a torsion upper release spring, an upper cinch cam torsional spring influencing said cinch cam and structural upper cam in an engaged upright position of said arm.

18. The upper latch assembly as described in claim 15, said housing further comprising a main housing and a cap housing.

19. The upper latch assembly as described in claim 18, further comprising a plurality of bushings extending between said main housing and cap housing, with an positioned of said bushings rotatably supporting said driven gear, upper structural cam and upper cinching cam.

20. The upper latch assembly as described in claim 15, said upper cinching cam further comprising an inwardly flanged portion engaged by said upper structural cam during release rotation of said driving gear.

21. The upper latch assembly as described in claim 16, further comprising meshing pluralities of teeth established between said driving gear and said driven gear.

22. The upper latch assembly as described in claim 15, further comprising a support plate for securing said housing, a mounting bracket securing said support plate to the truck.

23. The upper latch assembly as described in claim 22, said arm further comprising an elongated and generally “L” shaped configuration with a first end mounted over a splined portion of said upper main pivot so that, upon said arm being pivoted fully in a downward direction, an inside surface of said arm contacting a stop rivet mounted to an upper edge of the support plate to define the fully down position of the upper split tailgate.

24. A latch assembly for pivotally securing a tailgate to a truck bed, comprising:
a housing defining a package interior containing a fixed sector for receiving a main pivot secured to the truck bed;
a rotatable pawl selectively engageable with circumferentially offset support surfaces of said sector corresponding to each of up, intermediate and down positions of the tailgate;
a cinch cam rotatably supported on one side of said pawl for engaging, in the up position, a support bushing secured to said sector at a location offset from said main pivot;
a cam follower rotatably supported on an opposite side of said pawl, said cam follower selectively engaging a rotatable pawl blocker supported by said support bushing during rotation of said housing about said main pivot, and in order to prevent said pawl from engaging said sector during pivoting between the up and down positions of the tailgate; and
a release gear for actuating said pawl to in turn displace said cinch cam from contact with said support bushing to initial downward rotation of the tailgate.
